(19) United States
(12) Patent Application Publication
(10) Pub. No.: US 2021/0011772 A1
(43) Pub. Date: Jan. 14, 2021

(54) MEMORY MANAGEMENT AND RESOURCE UTILIZATION ON SERVICE HOSTING COMPUTING DEVICES

(71) Applicant: Facebook, Inc., Menlo Park, CA (US)

(72) Inventors: Qi Zhou, Sunnyvale, CA (US); Raymond Ng, Palo Alto, CA (US); Jianlong Zhong, Menlo Park, CA (US); Lisa Guo, Los Altos, CA (US)

(21) Appl. No.: 16/530,083

(22) Filed: Aug. 2, 2019

Related U.S. Application Data
(60) Provisional application No. 62/873,974, filed on Jul. 14, 2019.

(51) Int. Cl. G06F 9/50

(52) U.S. Cl. CPC G06F 9/5027; G06F 9/5016

(57) ABSTRACT

The present disclosure relates to systems, non-transitory computer-readable media, and methods of a process management system that improves memory management and resource utilization on host devices that utilize a pre-fork worker process model (e.g., uWSGI). For example, the process management system can utilize the memory consumption of the host device to determine how many worker processes to terminate as well as which worker processes to terminate. In addition, the process management system can utilize adaptive respawning to determine when to respawn each of the terminated worker processes.

### CROSS-REFERENCE TO RELATED APPLICATIONS

This application claims the priority to and the benefit of U.S. Provisional Patent Application No. 62/873,974, filed Jul. 14, 2019, which is incorporated herein by reference in its entirety.

### BACKGROUND

Recent years have witnessed significant technological improvements in hardware and software platforms for engaging with digital content and services on the Internet. For example, as the area of digital media sharing continues to increase in popularity, service hosting systems providing the digital media need to allocate additional computing resources to meet the increasing demand. Certainly, across the Internet and other networks, web and other service hosting systems continue to advance, improve, and develop to meet the increasing demands of users desiring to access digital content and services.

To meet rising demands, many conventional service hosting systems employ a pre-fork service hosting model. For example, a pre-fork service hosting model includes a master process and one or more worker processes on a host computing device (e.g., a host server providing a desired service or digital content). Worker processes (or simply “workers”) are copies of the master process and handle incoming requests. By creating additional workers, conventional systems can service multiple incoming requests concurrently.

Despite these advancements, however, conventional service hosting systems suffer from a number of problems in relation to efficiency, accuracy, and flexibility of operations, particularly with respect to utilizing a pre-fork service hosting model. For example, conventional systems struggle with efficiently utilizing and reclaiming memory. When creating workers on a host device (e.g., a server), workers are provided with an initial allocation of memory on the host device. Over time, however, due to memory leaks, memory fragmentation, and other issues, the memory consumption of the workers increase on the host device. This increase in memory consumption results in decreased reliability and efficiency of the host system (e.g. due to out-of-memory errors and memory swapping errors).

Some conventional systems have attempted to solve this memory consumption growth issue by terminating workers who are consuming large amounts of memory. However, when a worker shares memory with the master process and/or with other workers, the amount of memory reclaimed on the host device can be much less than expected. In these cases, the termination of the worker results in an unnecessary termination of the worker as well as yields lower than expected memory savings on the host device.

As an additional problem, terminated workers often need to be restarted to accommodate incoming requests. However, the startup costs of creating a new worker are not insignificant. For example, initiation procedures, memory allocation, cache removal, and cache repopulation each cost memory and computing resources of the host device. Thus, when a worker is unnecessarily terminated, the host device can actually waste memory and computing resources (e.g., at the CPU) to create new workers. Indeed, the computing costs of respawning the unnecessarily terminated worker often outweigh the benefit gained from the reclaimed memory.

Moreover, conventional systems often inefficiently maintain more workers than needed for large amounts of time. For instance, it is not uncommon for 20% to 40% of the workers to remain idle for around 90% of the time, waiting for a surge in incoming requests. While sitting idle, workers lock up memory on the host device. Additionally, idle workers can require additional computing resources to be maintained despite not processing any requests. As a result, other applications and system functions on the host system are unable to use these wasted resources.

Conventional systems are also inaccurate. In particular, when computing resources on the host device are reduced, spikes occur with respect to both memory usage and processing. Indeed, limited computing resources on a host device can result in a higher number of processing contentions, buffering issues, as well as cache pollution. As a result, the host device becomes more unstable and unable to accurately process operations without errors.

Conventional systems are also inflexible, as mentioned above, conventional systems often have a large number of idle workers. The number of workers is generally defined in a static configuration file. Indeed, conventional systems will continue to maintain the same static number of workers, even if many workers are idle. As described above, this inflexibility results in inefficient use of computing resources, increased processing errors, and decreased reliability by the host deceive.

These, along with additional problems and issues, exist with regard to conventional networking systems.

### SUMMARY

Embodiments of the present disclosure provide benefits and/or solve one or more of the foregoing or other problems with systems, non-transitory computer-readable media, and methods for improving memory management and resource utilization on host devices that utilize a pre-fork worker process model. For instance, the disclosed systems can optimally determine when to terminate worker processes (or simply “workers”) that are consuming excess memory on a host device, which results in significant memory savings on the host device as well as stabilizes the host device. In addition, the disclosed systems can dynamically adjust the number of workers based on the current needs, thus, greatly reducing otherwise wasted computing resources on the host device.

To illustrate, in a number of embodiments, the disclosed systems execute a pre-fork worker process model at a host device to process incoming requests utilizing multiple workers that share memory. While processing the incoming requests, the disclosed systems can identify a host memory amount corresponding to the memory utilized by the pre-fork worker process model at the host device. In addition, based on detecting that the host memory amount satisfies a memory threshold, the disclosed systems can terminate one or more workers.

As mentioned above, the disclosed systems can also dynamically adjust the number of workers. To illustrate, in various embodiments, the disclosed systems can detect one or more terminated workers. Further, the disclosed systems can determine whether one or more conditions are satisfied, such as an incoming queue threshold being met and/or an idle worker threshold being met. While the conditions are satisfied, the disclosed systems can prevent the terminated workers from respawning within the pre-fork worker process model. However, when one or more of the conditions are no longer satisfied, the disclosed systems can respawn one or more of the terminated processes.

Additional features and advantages of one or more embodiments of the present disclosure are provided in the description which follows, and in part will be apparent from the description, or may be learned by the practice of such example embodiments.

### BRIEF DESCRIPTION OF THE DRAWINGS

The detailed description provides one or more embodiments with additional detail through the use of the accompanying drawings, as briefly described below.

FIG. 1 illustrates an overview block diagram of improving memory management and resource utilization on host devices that employ a pre-fork worker process model in accordance with one or more embodiments.

FIG. 2 illustrates a schematic diagram of an environment in which a networking system having a process management system operates in accordance with one or more embodiments.

FIGS. 3A-3B illustrate schematic diagrams of an example pre-fork worker process model creating and terminating worker processes in accordance with one or more embodiments.

FIG. 4 illustrates a sequence diagram of improving memory management within a pre-fork worker process model in accordance with one or more embodiments.

FIGS. 5A-5B illustrate schematic diagrams of monitoring memory consumption of the pre-fork worker process model in accordance with one or more embodiments.

FIG. 6 illustrates a state diagram of determining when to terminate worker processes to free up memory on a host device in accordance with one or more embodiments.

FIGS. 7A-7B illustrate graphics of determining when and how many worker processes to terminate on the host device in accordance with one or more embodiments.

FIGS. 8A-8B illustrate schematic diagrams of delaying terminated worker processes from restarting within the pre-fork worker process model in accordance with one or more embodiments.

FIG. 9 illustrates a state diagram of adaptively restarting terminated worker processes in accordance with one or more embodiments.

FIG. 10 illustrates a block diagram of the process management system within the networking system in accordance with one or more embodiments.

FIG. 11 illustrates a flowchart of a series of acts of improving memory management within a pre-fork worker process model in accordance with one or more embodiments.

FIG. 12 illustrates a flowchart of a series of acts of adaptively restarting terminated worker processes in a pre-fork worker process model in accordance with one or more embodiments.

FIG. 13 illustrates a block diagram of an example computing device for implementing one or more embodiments of the present disclosure.

FIG. 14 illustrates an example network environment of a networking system in accordance with one or more embodiments.

### DETAILED DESCRIPTION

One or more embodiments of the present disclosure include a process management system that improves memory management and resource utilization on host devices that utilize a pre-fork worker process model (e.g., uWSGI). For example, the process management system can utilize the overall memory consumption on the host device to determine how many worker processes to terminate as well as which worker processes to terminate. In addition, the process management system can utilize adaptive respawning to determine when to respawn each of the terminated worker processes.

To illustrate, in a number of embodiments, the process management system can execute a pre-fork worker process model at a host device that handles multiple incoming requests from client devices. While processing the incoming request utilizing multiple workers sharing memory with the master process, the process management system can determine an amount of host memory being consumed at the host device by the pre-fork worker process model. In addition, based on the process management system determining that the host memory utilization amount reaches a memory threshold, the process management system can initiate termination of one or more workers to recapture memory as well as stabilize overall processing at the host device.

Additionally, as mentioned above, the process management system can dynamically adjust the number of workers. To illustrate, in various embodiments, the process management system detects one or more terminated workers. Further, the process management system can determine whether one or more conditions are satisfied, such as an incoming queue threshold and an idle worker threshold. While the conditions are satisfied, the process management system can prevent terminated workers from respawning within the pre-fork worker process model. Further, when one or more of the conditions are no longer satisfied, the process management system can respawn one or more of the terminated processes.

As mentioned above, the process management system can utilize a pre-fork worker process model. For example, in various embodiments, the process management system creates or forks a number of worker processes (or simply “workers”) from a master process (or simply “master”) on a host device (e.g., a server device). The workers can handle incoming requests (e.g., web request) from client devices or other servers where the requests are for services or digital content provided by the host device.

As also mentioned above, the process management system can monitor memory consumption on the host device utilized by the pre-fork worker process model. For example, in various embodiments, the process management system monitors and determines when the host memory utilization amount reaches a memory threshold, such as a lower bound memory threshold. When a memory threshold is satisfied, the process management system can begin to terminate workers within the pre-fork worker process model.

In some instances, the process management system can determine an optimal number of workers to terminate. For example, in one or more embodiments, the process management system can determine how many workers to terminate based on the host memory utilization amount, a lower bound memory threshold, an upper bound memory threshold, and the total number of process workers. In some embodiments, the process management system utilizes a quadratic algorithm to determine the optimal number of workers to terminate.

In addition to identifying the number of workers to terminate, the process management system can also determine which workers to terminate. For example, in various embodiments, the process management system identifies how much memory each worker is consuming (e.g., a worker memory amount). Using the identified number of workers to terminate, the process management system can terminate the workers that are consuming the highest amounts of worker memory.

In various embodiments, the process management system can determine how to terminate a worker (e.g., a termination type). For example, in some embodiments, the process management system can send a termination signal to a worker that triggers immediate termination. In alternative embodiments, the process management system can send a termination signal to the worker to delay termination until its current request is complete. In some embodiments, the decision as to which termination method to utilize is based on one or more host memory thresholds, as described below.

As mentioned above, the process management system can respawn a terminated worker. In some embodiments, the process management system immediately respawns a worker upon termination. In other embodiments, the process management system delays respawning one or more terminated workers based on current processing conditions of the pre-fork worker process model (e.g., based on incoming requests and available workers).

In particular, in many embodiments, the process management system can improve resource utilization by adaptively respawning terminated workers. As mentioned above, the process management system can delay respawning based on one or more delay conditions. For example, the process management system delays respawning terminated workers based on an incoming queue threshold and/or an idle worker threshold.

In one or more embodiments, the incoming queue threshold corresponds to the number of incoming requests sitting in the incoming queue (e.g., listening queue) waiting to be assigned and processed by workers. For example, the process management system determines that the incoming queue threshold is satisfied when a number of incoming external requests is at or above the incoming queue threshold. In a similar manner, in one or more embodiments, the idle worker threshold corresponds to the number of idle non-terminated workers of the pre-fork worker process model. For example, the process management system can determine that the idle worker threshold is satisfied when a number of idle workers is at or below the idle worker threshold.

Moreover, the process management system can determine an optimal number of terminated workers to respawn based on current processing conditions of the pre-fork worker process model. For example, in various embodiments, upon determining that one or more delay conditions are no longer met, the process management system can respawn a terminated worker and assign an incoming request to the respawned worker. Then, the process management system can determine whether the addition of the respawned worker causes the delay conditions to be satisfied or if an additional worker should be respawned.

As explained above, the process management system provides numerous advantages, benefits, and practical applications over conventional systems and methods. For instance, the process management system greatly increases the computing efficiency of a host device by effectively stabilizing the memory used by the pre-fork worker process model at the host device. By monitoring the pre-fork worker process model as a whole, rather than smaller pieces (which themselves are often inaccurate), the process management system can more efficiently manage memory usage of the pre-fork worker process model on the host device.

Indeed, by monitoring the memory amount used by the entire pre-fork worker process model, the process management system can better maintain a steady level of memory consumption. In particular, the process management system can determine when memory consumption needs to be reduced, how much to reduce the consumed memory, how many workers to terminate, and which workers to terminate to achieve the desired amount of memory reduction.

Moreover, the process management system improves the efficiency of the host device by greatly reducing the number of workers that were terminated unnecessarily. As described above, respawning a terminated worker requires significant computing costs, such as CPU processing resources. Thus, reducing unnecessarily terminated workers reduces the respawn rate, which, in turn, saves both computer processing and memory allocation costs at the host device.

Likewise, the process management system improves the efficiency of the host device by reducing the number of idle processes of the pre-fork worker process model. For example, rather than continually respawning terminated workers, the process management system first determines whether a terminated worker should be respawned and available for processing incoming requests based on the current demand of the incoming requests. In this manner, idle workers are not hijacking memory that could be more efficiently used elsewhere by the host device.

As evidence of the computational improvements, the inventors had measured an 11% capacity improvement on a host device by implementing embodiments of the process management system. Indeed, these improvements to both memory management and computing processing are significant with respect to the efficiency of host devices.

Further, the process management system provides increased accuracy to the host device over conventional systems. For example, by providing more memory, the host device suffers from fewer memory management errors as well as fewer processing errors, which result in more accurate operations. Additionally, by reducing the number of memory utilization spikes through better memory management and stability, the process management system provides improved reliability of the host device in processing incoming requests.

Additionally, the process management system provides increased flexibility over otherwise rigid conventional systems. As mentioned above, the process management system intelligently adapts the number of workers at the host device based on the current demand. In contrast, conventional systems largely maintain the number of workers indicated in a configuration file irrespective of the current demand (e.g., conventional systems will respawn terminated workers even if idle workers are present).

As illustrated by the foregoing discussion, the present disclosure utilizes a variety of terms to describe features and advantages of the process management system. Additional detail is now provided regarding these and other terms used herein. For example, as used herein, the term “pre-fork worker process model” refers to a hosting service model that includes a processing clustering made up of a master process, which forks or creates one or more duplicate worker processes before incoming requests are received. A master process and the worker processes are often assigned with a process identifier (e.g., PID). Additionally, a pre-fork worker process model commonly operates on a server device (i.e., the host device), such as a web server. An example of a pre-fork worker process model includes uWSGI, which provides a full software stack for building hosting services on a server device. The pre-fork worker process model can be coded in a computer scripting language, such as Python, C, or C+.

The term “terminate,” as used herein, refers to killing a worker process on a host device. For example, the process management system sends a termination signal or command (e.g., sigkill in LINUX) to a worker process to be terminated. Additionally, the terms “respawn” and “restart” refer to re-initializing a previously terminated worker process. In some embodiments, the process management system respawns a terminated worker by maintaining the same process identifier (e.g., PID), but provide the worker with a new allocation of resources (e.g., memory).

As used herein, the terms “incoming external request,” “incoming request,” or simply “request” refers to a call for a service or digital content from a device remote from the host device. For example, a client device provides a request to the host device for an image. In another example, a second server device provides a request to the host device for search results. Indeed, requests can come from users and/or other computing devices (e.g., server devices). Largely, requests are web requests made via the Internet.

The term “memory amount” refers to an amount of allocated and/or consumed memory on a host device. In various embodiments, the memory amount refers to memory allocated to one or more processes in a cache or RAM (e.g., physical or virtual) of a host device. In additional, or alternative, embodiments, the memory amount includes other types of memory on the host device, such as disk storage, solid-state memory, flash memory, or another type of non-transitory memory.

Additionally, the terms “host memory utilization amount” (or simple “host memory amount”) refers to an amount of memory utilized or consumed by a pre-fork worker process model as well as other processes on the host device. Often, the process management system (e.g., a background thread in the master process) performs a system call to the host device (e.g., “reading/proc/meminfo” in LINUX where /proc/meminfo is a file) to obtain the host memory amount. In some embodiments, the host memory amount includes the shared memory used across the pre-fork worker process model. In alternative embodiments, the host memory amount includes the memory of a worker process shared with the master process and/or other worker processes.

Likewise, the term “worker memory amount” refers to an amount of memory consumed by a worker process. In various embodiments, the worker memory amount refers to a resident set size (RSS) of consumed memory. In one or more embodiments, the worker memory amount refers to a proportional set size (PSS) and or a unique set size (USS) of consumed memory by a worker process. For example, the RSS can refer to the PSS plus the USS of a worker process.

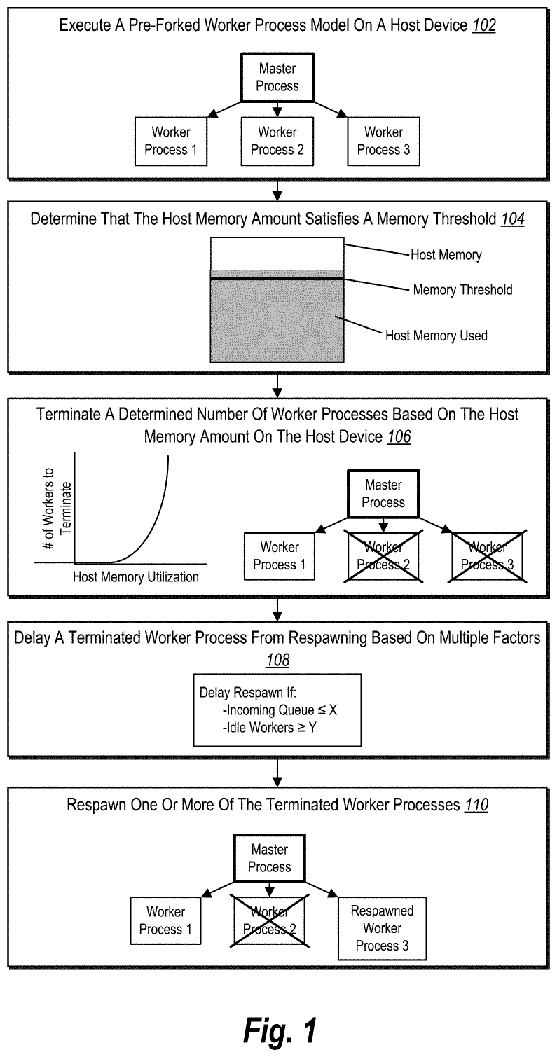

Additional detail will now be provided regarding the process management system in relation to illustrative figures portraying example embodiments and implementations of the process management system. For example, FIG. 1 illustrates an overview of improving memory management and resource utilization on host devices that employ a pre-fork worker process model in accordance with one or more embodiments. In particular, FIG. 1 includes a series of acts 100 performed by the process management system to improve the operational capacity of a host device implementing the process management system.

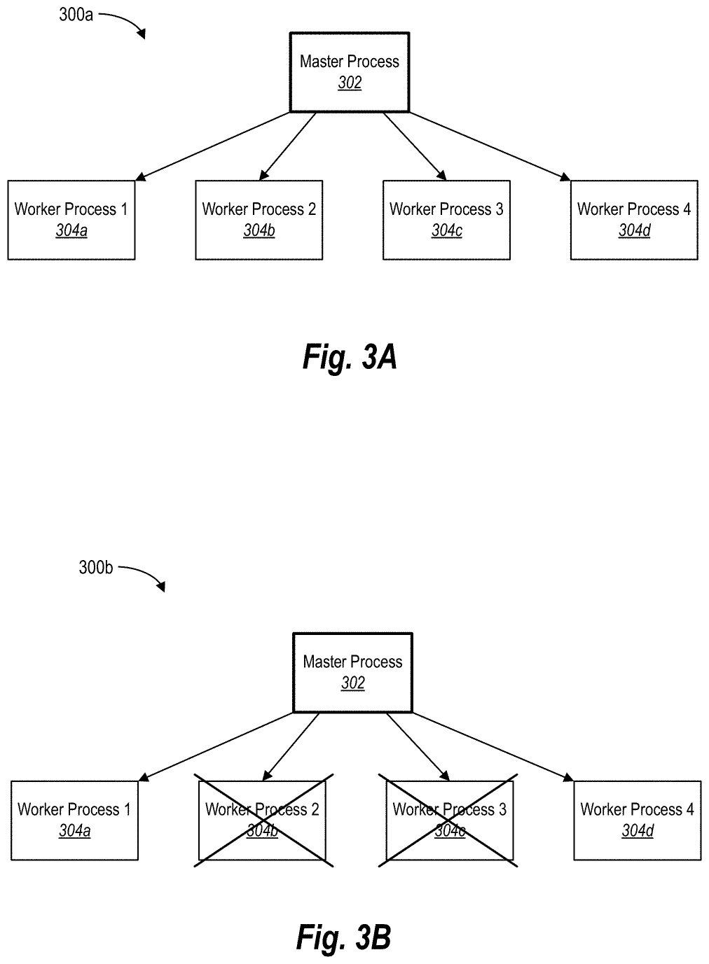

As shown, the series of acts 100 includes an act 102 of the process management system executing a pre-fork worker process model on a host device. For example, the host device is a server device that provides one or more services or digital content to requesting client devices of users. As part of fulfilling incoming requests, the host device implements the process management system, which utilizes a pre-fork worker process model that includes a master process (or simply “master”) and worker processes (or simply “workers”). Additional detail regarding the act 102 is provided below in connection with FIGS. 3A-3B

In addition, the series of acts 100 includes an act 104 of the process management system determining that the host memory amount satisfies a memory threshold. For example, as the workers process incoming requests, they begin to consume more memory (e.g., RAM) on the host device. Additionally, when the host device is primarily a hosting server for providing services and/or digital content, the server processes consume the majority of the memory on the host device. Indeed, the pre-fork worker process model (e.g., uWSGI) consumes most of the host's physical memory (e.g., RAM) on the host servers.

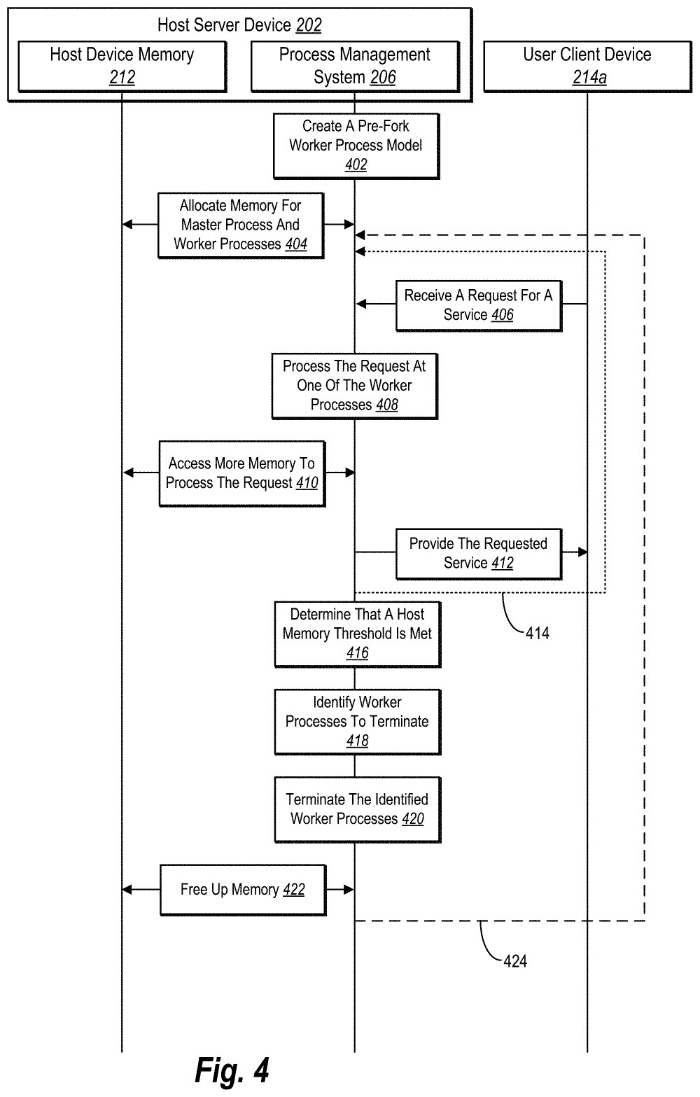

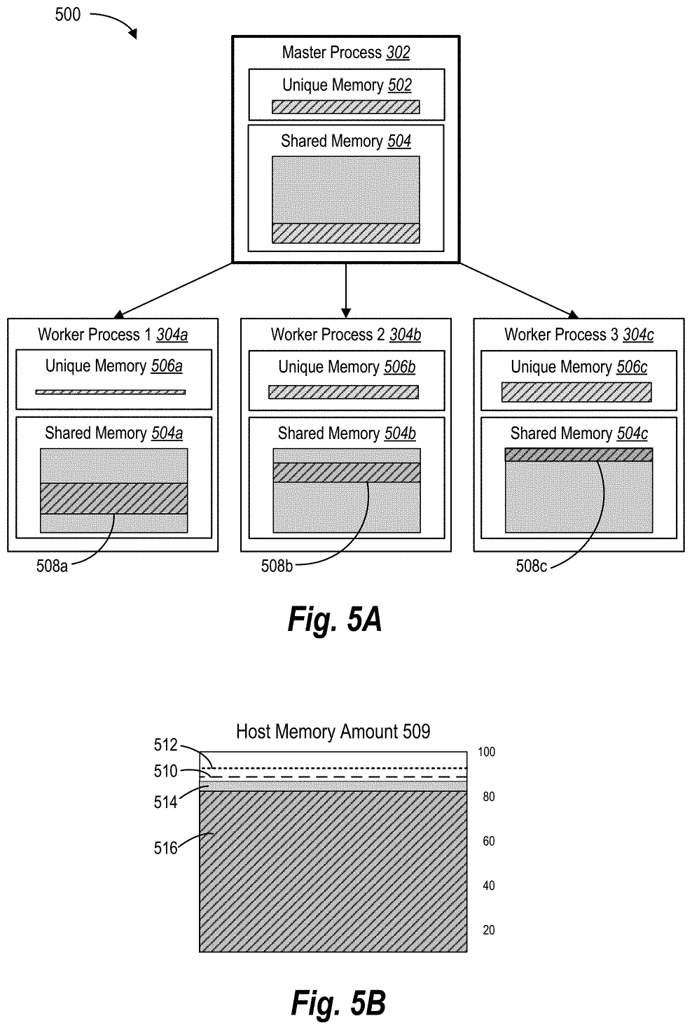

Accordingly, the process management system can monitor the overall memory consumption by the workers of the pre-fork worker process model on the host device. Further, the process management system can determine when the host memory amount consumed on the host device reaches one or more memory thresholds. Additional detail regarding the act 104 is provided below in connection with FIG. 4 and FIGS. 5A-5B.

Based on determining that the host memory amount satisfies the memory threshold on the host device, the process management system can terminate one or more workers. To illustrate, the series of acts 100 includes an act 106 of the process management system terminating a determined number of worker processes based on the host memory amount on the host device. For example, as detailed below, the process management system can determine an optimal number of workers to terminate to maintain a specified memory consumption range on the host device. In many embodiments, the number of workers to terminate is based on the host memory amount. For instance, as the host memory amount rises, the process management system determines to terminate more workers, as shown in connection with the act 106.

In additional embodiments, the process management system can also determine which workers to terminate. For example, the process management system identifies the amount of memory that each worker is consuming (i.e., worker memory amount). Additionally, the process management system can rank the workers based on their worker memory amount. Then, the process management system can terminate the workers with the highest worker memory amount up to the determined number of terminated workers. Additional detail regarding the act 106 is provided below in connection with FIGS. 4, 6, and 7A-7B.

Upon terminating a worker, the process management system can respawn the terminated worker. However, based on the current demand of incoming requests, the process management system may desire to delay restarting the worker if the worker will sit idle for a time. To illustrate, the series of acts 100 includes the act 108 of the process management system delaying a terminated worker process from respawning based on multiple factors.

In various embodiments, the act 108 can include delaying a terminated worker from respawning based on the number of incoming requests. For example, if the incoming request queue includes over a threshold number of requests, the process management system can determine not to delay respawning the terminated worker. Otherwise, if the number of requests in the incoming queue is below the threshold number of requests, the process management system can delay respawning the terminated worker.

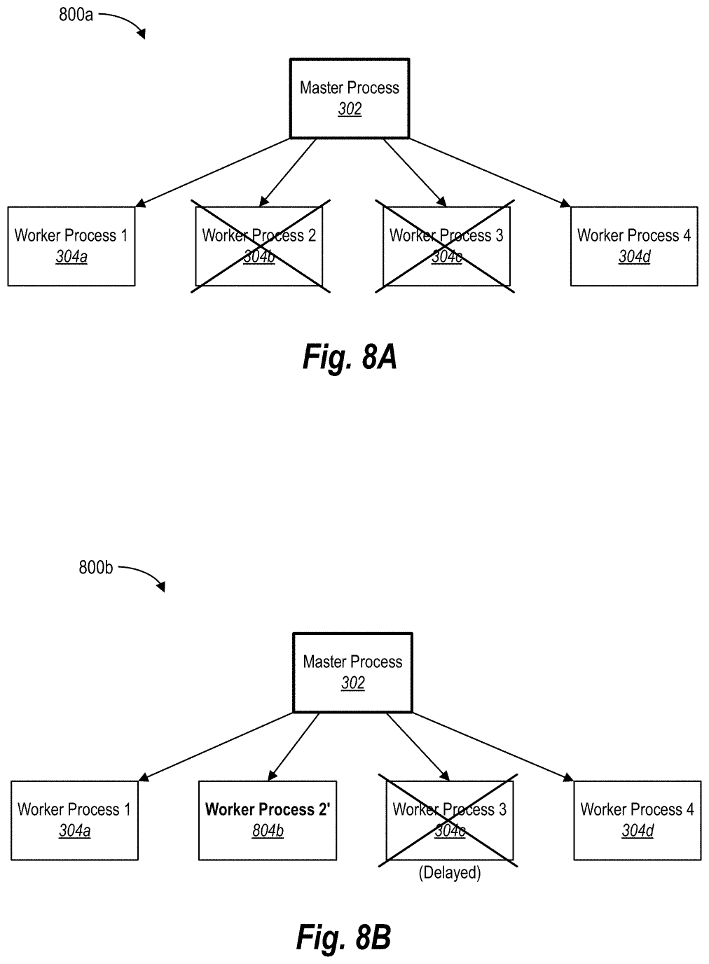

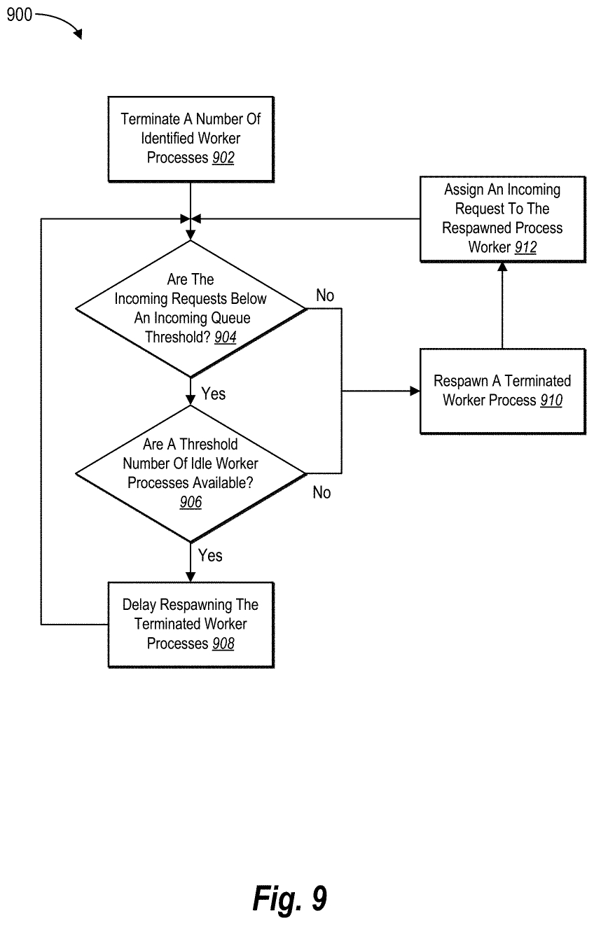

Additionally, or in the alternative, an act 108 can include delaying a terminated worker from respawning based on the number of idle or available workers. For example, in one or more embodiments, if the number of idle workers is over an idle workers threshold, the process management system can delay respawning the terminated worker. In some embodiments, the process management system can delay respawning the terminated worker while the number of requests in the incoming request queue is less than the number of idle workers. Additional detail regarding the act 108 is provided below in connection with FIGS. 8A-8B and 9.

FIG. 1 also shows that the series of acts 100 includes an act 110 of the process management system respawning one or more terminated worker processes. For example, upon terminating a worker (or upon determining to stop delaying), the process management system can respawn a terminated worker. In some embodiments, the process management system determines to respawn less than all of the workers of the pre-fork worker process model. Additional detail regarding the act 110 is provided below in connection with FIG. 9.

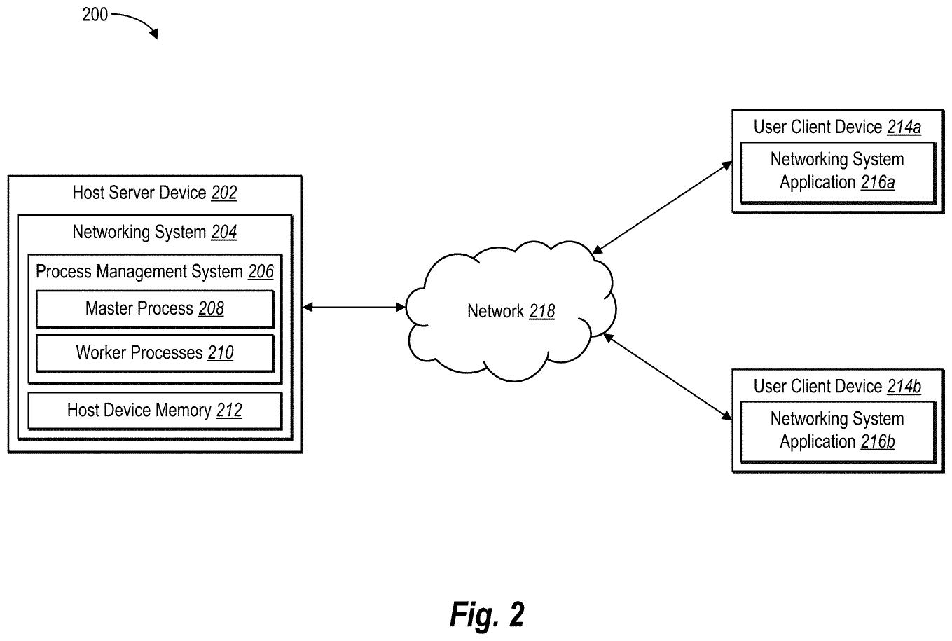

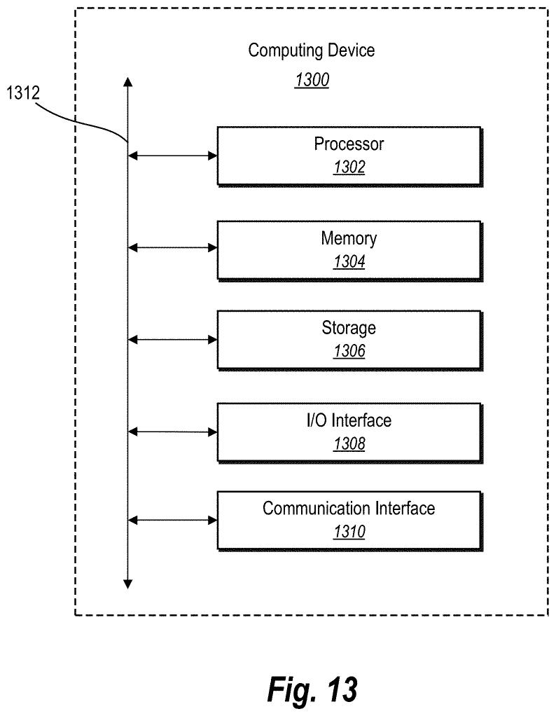

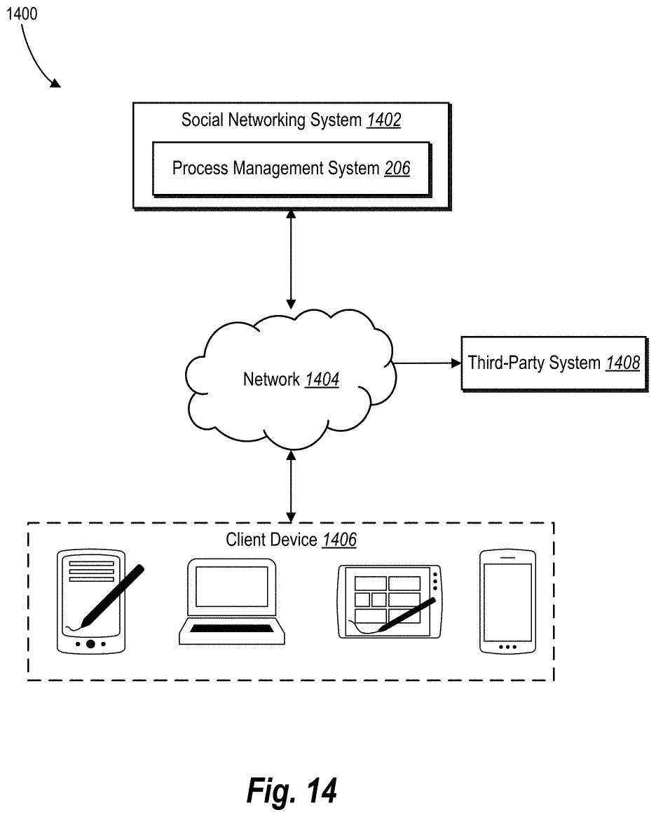

FIG. 2 illustrates a schematic diagram of one embodiment of an example environment 200 in which a process management system 206 can operate. As shown, the environment 200 includes a host server device 202 (or simply “host device 202”) connected to multiple client devices 214a, 214b via a network 218. Examples of computing devices (e.g., the host device 202 and the client devices 214a, 214b) and networks (e.g., the network 218) are described in more detail below with respect to FIGS. 13 and 14.

As shown, the host device 202 includes a networking system 204 having the process management system 206. The host device 202 also includes host device memory 212. As also shown, the user client devices 214a, 214b each include a networking system application 216a, 216b. In many embodiments, the networking system application 216a, 216b on the client devices 214a, 214b correspond to the networking system 204 on the host device 202.

As mentioned, the environment 200 includes the host device 202. In one or more embodiments, the host device 202 may generate, store, receive, and transmit a variety of types of data, including networking data, services (e.g., web services), and or digital content (e.g., digital content items) corresponding to the networking system 204. For example, the host device 202 may receive data from the first user client device 214a and send the data to the second user client devices 214b.

In many example embodiments, the host device 202 is a data server that processes incoming web requests. For example, the host device 202 comprises a web-hosting server. In another example, the host device 202 comprises a communication server. Additional detail regarding the host device 202 is provided below with respect to FIG. 13.

As shown, the host device 202 includes the networking system 204 and the process management system 206. Indeed, in one or more embodiments, the networking system 204 can implement all or a portion of the networking system 204 and/or the process management system. Further, in some embodiments, the process management system 206 is implemented on a different server device than the networking system 204 (e.g., the process management system 206 utilizes resources of multiple different host devices in a hosting cluster).

In various embodiments, the networking system 204 can connect users to each other and enable users to share digital content with each other. For example, the networking system 204 facilitates users to send content items to co-users directly, share content items with specific groups of co-users, and/or share content items to co-users of the networking system 204 generally (e.g., public posts). Further, the networking system 204 can include a social networking system, an electronic messaging system, or another type of networking system that enables users to communicate with each other. Additional detail regarding the networking system 204 is provided below in connection with FIG. 14.

As mentioned above, the process management system 206 can improve the memory management and resource usage on the host device 202, and particularly when the host device 202 is executing a pre-fork worker process model (e.g., uWSGI). To this end, the process management system 206 includes a master process 208 (or simply “master 208”) and one or more worker processes 210 (or simply “workers 210”). In various embodiments, the master 208 and one or more workers 210 utilize and/or consume portions of the host device memory 212 of the host device 202. Embodiments of the process management system 206 are further described throughout this disclosure.

In some embodiments, the networking system 204 and/or the process management system 206 can include one or more applications or services running on the host device 202. For example, the process management system 206 can include a web hosting application that allows the client devices (i.e., user client devices 214a, 214b) to interact with digital content and/or services provided by the host device 202. To illustrate, in one or more, the first client device 214a can run a web application (e.g., a web browser) to allow a user to access, view, and/or interact with a webpage or website hosted at the host device 202.

As mentioned above, the client devices 214a, 214b can include the networking system applications 216a, 216b. In various embodiments, the networking system applications 216a, 216b communicate and exchange data with the networking system 204. For example, in some embodiments, the networking system applications 216a, 216b are software applications corresponding to the networking system 204, such as an application that enables the networking system 204 to provide and display digital content on the client devices 214a, 214b. Additionally, the networking system applications 216a, 216b can receive user input at the client devices 214a, 214b and provide the information to the networking system 204.

Although FIG. 2 illustrates a particular arrangement of devices among the host device 202, the user client devices 214a, 214b, and the network 218, various additional arrangements are possible. For example, the environment 200 can include a social networking system on a separate server device. Similarly, although the environment 200 of FIG. 2 is depicted as having various components, the environment 200 may have additional or alternative components. For example, the networking system 204 and/or the process management system can be implemented across multiple server devices.

Turning now to FIGS. 3A-3B, additional detail is provided regarding pre-fork worker process models. In particular, FIGS. 3A-3B illustrate schematic diagrams of an example pre-fork worker process model creating and terminating worker processes in accordance with one or more embodiments. As shown, FIG. 3A includes a pre-fork worker process model 300a that includes a master process 302 (or simply “master 302”) and multiple worker processes 304a-304d (or simply “workers 304a-304d”).

In a number of embodiments, the process management system 206 can load the master 302 on the host device 202 to handle incoming requests for a service or digital content. In order to handle multiple processes at the same time, the process management system 206 can fork the master 302 into the workers 304a-304d, as each of the workers 304a-304d can handle one request at a time. For instance, upon starting of the master 302, the process management system 206 (e.g., via the master 302) reads in a static configuration file that indicates an initial number of workers to fork. In this manner, the process management system 206 includes an initial number of workers to handle incoming requests before the requests start arriving.

In one or more embodiments, the workers 304a-304d are each a copy of the master 302. In some embodiments, the workers 304a-304d are modified versions of the master 302, such as a light-weight version. In example embodiments, the workers 304a-304d have different parameters from the master 302. For example, the process management system 206 allocates a smaller memory portion on the host device 202 for the workers 304a-304d.

In one or more embodiments, the process management system 206 shares an amount of memory between the master 302 and the workers 304a-304d. For example, each of the workers 304a-304d includes a unique memory amount and a shared memory amount that the workers 304a-304d can consume in processing requests. In additional embodiments, or in the alternative, the process management system 206 shares an amount of memory among the workers 304a-304d, such as worker memory shared between two of the workers 304a-304d.

As mentioned above, the process management system 206 forks and initializes the workers 304a-304d based on parameters included in a configuration file. For example, the configuration file specifies the number of workers 304a-304d to initially spawn, how much unique and/or shared memory to allocate to each worker, when to terminate a worker, a maximum number of respawned workers, a maximum number of total workers, and other configurable parameters.

In addition, the process management system 206 can terminate one or more of the workers 304a-304d based on one or more factors. Often, the process management system 206 terminates workers 304a-304d to reclaim memory being consumed on the host device 202 based on the memory of individual workers growing over their lifespan. In particular, if a worker has significantly increased its memory consumption above the amount initially allocated to it, terminating the worker and replacing it with a new worker can recover the excess memory. To illustrate, FIG. 3B shows an updated pre-fork worker process model 300b, in which the process management system 206 terminates the second worker 304b and the third worker 304c.

In one or more embodiments, the process management system 206 can terminate a worker when the amount of memory consumed by the worker exceeds a memory threshold (e.g., a single worker memory threshold). For example, in one or more embodiments, each time the worker processes an incoming request, the worker collects its memory usage (e.g., a background thread to collect its RSS). If the memory usage of the individual worker is above the single worker memory threshold, the process management system 206 can send a notification to the worker to be terminated upon completion of its current request. In some embodiments, the process management system 206 can terminate a worker after it has processed a threshold number of requests (e.g., terminate after processing 20 requests).

In some instances, however, employing the above method of terminating a worker results in terminating the worker unnecessarily. For example, in the case of the worker sharing memory with the master 302 and/or other of the workers 304a-304d, the collected memory usage of the worker (e.g., the RSS of the worker) may not accurately indicate how much memory the worker is actually consuming because the worker is consuming a large amount of shared memory. In other words, when a worker is consuming shared memory, a large memory usage (e.g., a high RSS) does not guarantee a larger amount of reclaimable memory upon terminating the worker. Thus, when a terminated worker does not yield at least a minimum amount of reclaimed memory (even if the worker had a high RSS), the worker was terminated unnecessarily.

As mentioned above, unnecessarily terminating a worker can result in inefficiencies and wasted computing resources (e.g., both memory and processing resources). For example, the startup computing costs of respawning a terminated worker can outweigh terminating the worker when less than the minimum amount of reclaimed memory is reclaimed. Indeed, the startup computational costs of respawning a terminated worker (e.g., memory allocation, cache removal, and cache repopulation) require both memory and computing resources of the host device. Accordingly, in various embodiments, the process management system 206 utilizes various alternative approaches to optimize worker termination, as described below in connection with FIG. 4.

To illustrate, FIG. 4 shows a sequence diagram of improving memory management within a pre-fork worker process model in accordance with one or more embodiments. As shown, FIG. 4 includes a series of acts with respect to the host server device 202 (or simply “host device 202”) and the user client device 214a. As also shown, the host device 202 includes the process management system 206 and the host device memory 212.

As shown, the series of acts includes an act 402 of the process management system 206 on the host device 202 creating a pre-fork worker process model. For example, the process management system 206 loads the master and forks one or more workers on the host device 202, as described above in connection with FIG. 3. In some embodiments, the process management system 206 creates multiple pre-fork worker process models on the host device 202.

In addition, the series of acts includes an act 404 of the process management system 206 allocating memory for the master process and the worker processes. For example, the process management system 206 allocates sections (e.g., blocks or pages) of memory from the host device memory 212 of the host device 202 for the master and the workers. In various embodiments, the process management system 206 allocates shared memory sections between the process model and the workers. In additional embodiments, the process management system 206 can also allocate portions of unique memory (e.g., non-sharable memory or USS) to the workers. Additional detail regarding shared and unique memory for workers is provided below with respect to FIGS. 5A-5B.

As shown, FIG. 4 includes an act 406 of the process management system 206 receiving a request for a service from the user client device 214a. For instance, the user client device 214a communicates with the host device 202 via a network to request a web service or digital content. For example, if the host device 202 provides digital images shared by users of a networking system, the user client device 214a can request to download one or more digital images from the host device 202.

In response to the incoming request from the user client device 214a, the process management system 206 can process the request. More particularly, the process management system 206 can assign the incoming request to one of the workers of the pre-fork worker process model. Accordingly, FIG. 4 shows the act 408 of the process management system 206 processing the request at one of the worker processes.

To illustrate, the pre-fork worker process model includes one or more idle workers that are “listening” for incoming requests. For instance, each of the workers is bound to a TCP socket (e.g., IP address and port) on which requests will be routed to the host device 202. When the request from the user client device 214a comes to the host device 202 over the socket, each of the idle workers attempts to pick up the request. However, the process management system 206 assigns the request to the worker that first picks up the request.

In various embodiments, while processing one or more subsequent requests, a worker begins to accumulate additional amounts of the host device memory 212 (e.g., physical memory or RAM) on the host device 202. For example, due to memory leaks, cache pollution, memory fragmentations, etc., that occur at the worker through processing incoming requests, the memory consumption of the worker increases. To illustrate, the series of acts includes the act 408 of the process management system 206 accessing more memory to process the request.

As shown, the series of acts includes an act 412 of the process management system 206 providing the requested service to the user client device 214a. For example, the worker processing the request can provide the user client device 214a with the desired digital content and/or data in response to the incoming request. Often, once the worker completes the incoming request, the worker becomes idle until it picks up a new request.

Because pre-fork worker process models commonly include multiple workers, and because each of the workers can increase their memory consumption over time, the collective memory consumption and usage of the workers can rapidly grow, including to the point where the host device 202 runs out of host device memory 212. Accordingly, in one or more embodiments, the process management system 206 monitors the host memory amount used by the pre-fork worker process model.

As shown, FIG. 4 includes an act 416 of the process management system 206 determining that a host memory threshold is met. For example, the process management system 206 periodically performs a system call (e.g., read memory_info) to the host device 202 to identify the amount of host device memory 212 (e.g., the host memory amount) that the pre-fork worker process model is consuming. In some embodiments, the process management system 206 utilizes a background thread at the master or a worker to determine the host memory amount. For example, in one or more embodiments, the process management system 206 identifies the host memory amount upon completing each process when a worker is to become idle/handle a new request. In alternative embodiments, the master can identify the host memory amount at regular time intervals (e.g., every 5, 30, 60, or 120 seconds).

Upon identifying the host memory amount, the process management system 206 can determine whether a host memory threshold is satisfied. For example, the host memory threshold can include an absolute or relative memory amount, such as 2 GB or 80% of the host device memory 212. If the host memory amount is below the host memory threshold, the process management system 206 can continue to process incoming requests utilizing its current workers, as shown by the dotted line 414. However, if the host memory amount has reached or exceeded the host memory threshold, the process management system 206 can begin to terminate workers to lower and/or maintain the memory consumption of the pre-fork worker process model.

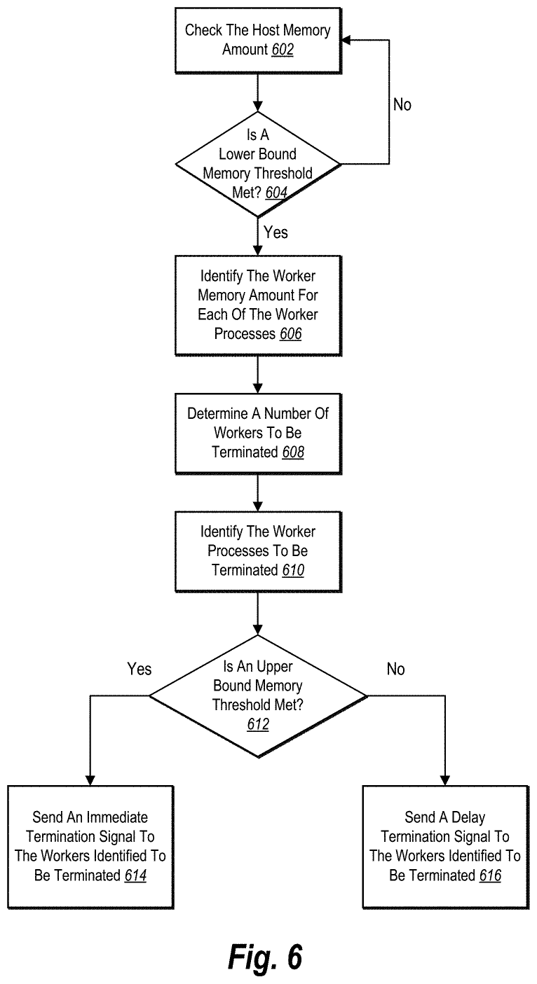

As shown in the act 418, the process management system 206 can identify worker processes to terminate based on determining that the workers are consuming too much memory on the host device 202 (e.g., the host memory threshold is reached). For example, the process management system 206 can determine how many workers to terminate as well as select which of the workers to terminate. In some embodiments, the process management system 206 terminates the workers consuming the most memory (e.g., shared and/or unique memory) up to a determined number of workers). Additional detail regarding identifying which workers to terminate is provided below with respect to FIG. 6.

FIG. 4 also includes the act 420 of the process management system 206 terminating the identified worker processes. In some embodiments, the process management system 206 delays termination of the identified workers until they are finished handling their current requests. In alternative embodiments, the process management system 206 immediately terminates one or more of the identified workers. Additional detail regarding terminating workers is provided below with respect to FIG. 6.

Upon terminating one or more workers, the process management system 206 releases the memory being used by those workers. To illustrate, FIG. 4 shows the act 422 of the process management system 206 freeing up memory on the host device 202 (i.e., the host device memory 212). In some embodiments, freeing up the host device memory 212 includes returning the pre-fork worker process model to its initial memory allocation state (or close to this state). In some embodiments, freeing up the host device memory 212 includes causing the pre-fork worker process model to drop to below its initial memory allocation state (e.g., when a number of workers are terminated, and their respawning is delayed). In either case, freeing up the host device memory 212 enables the host device 202 to operate more efficiently and accurately, as described above.

In many embodiments, the process management system 206 can return to receiving and processing incoming requests, as indicated by the dashed line 424. Indeed, once the memory is reclaimed from the host device 202, the process management system 206 can repeat the acts 406-412 to fulfill incoming requests. Then, when the host memory threshold is satisfied, the process management system 206 can repeat the acts 416-420 to free up memory on the host device 202 as well as stabilize the amount of memory utilized by the pre-fork worker process model.

The series of acts in FIG. 4 illustrates a number of discrete acts. However, in some embodiments, one or more sets of acts are performed in parallel or overlapping with each other. For example, in various embodiments, the process management system 206 performs the act 402 in connection with the act 404. Similarly, in one or more embodiments, the process management system 206 performs the act 408 along with the act 410.

Turning to FIGS. 5A-5B, additional detail regarding memory consumption of worker processes is described. For example, FIGS. 5A-5B illustrate schematic diagrams corresponding to monitoring memory consumption of the pre-fork worker process model in accordance with one or more embodiments. In particular, FIGS. 5A-5B illustrate utilizing a shared memory across the master process and worker processes of a pre-fork worker process 500 relative to the physical memory of the host device. Notable, FIGS. 5A-5B are merely conceptual examples for purposes of explanation.

To illustrate, FIG. 5A shows a pre-fork worker process model 500. The pre-fork worker process model 500 includes the master process 302 (or simply “master 302”) and the worker processes 304a-304c (or simply “workers 304a-304c”), as introduced previously. As shown, the master 302 includes the unique memory 502 (i.e., utilized unique memory) and shared memory 504 (i.e., utilized shared memory). Similarly, the workers 304a-304c include unique memory 506a-506c (e.g., USS) and shared memory 504 (e.g., PSS).

In various embodiments, the process management system 206 can allocate the unique memory 502 to the master 302 as well as allocate unique memory 506a-506c to the workers 304a-304c. For example, in one or more embodiments, the process management system 206 allocates portions (e.g., blocks or pages) of memory to each of the workers 304a-304c, where some of the allocated portions overlap with those of the shared memory 504. Thus, if when a worker accesses a sub-portion of memory corresponding to the shared memory 504 within the blocks allocated to the master 302, the host device (e.g., the operating system) marks that sub-portion as shared.

As shown, the master 302 is consuming both the unique memory 502 and a portion of the shared memory 504 allocated from the host device memory, which is indicated by the pattern area. For example, in various embodiments, the master 302 may utilize portions of the unique memory 502 and/or the shared memory 504 when performing system-wide operations, such as forking workers, determining when a host memory threshold is satisfied, or determining which workers to terminate. Notably, to provide context with respect to the shared memory 504, the shaded area of the shared memory 504 indicates the total allocation of shared memory being used by the master 302 and the workers 304a-304c. Further, the overlapping patterned areas indicates the amount be used by a particular process.

As also shown, the first worker 304a is utilizing a small first amount of unique memory 506a (e.g., a unique memory utilization amount) as well as utilizing a large portion of the shared memory, shown as the shared memory 508a. Indeed, when allocating its memory, the first worker 304a allocates a small block memory not corresponding to the shared memory allocation (i.e., unique memory 506a) and a larger block of memory (e.g., the shared memory amount 508a) of the shared memory 504 allocated to the master 302. The second worker 304b is utilizing the second amount of unique memory 506b as well as a part of the shared memory 504 (e.g., shown as the shared memory consumption 508b). Likewise, the third worker 304c is utilizing a third amount of unique memory amount 506c as well as a part of the shared memory 504 (e.g., shown as the shared memory consumption 508c).

In various embodiments, while each of the workers 304a-304c show the amount of shared memory 504a-504c they are individual consuming, in many instances, it can be difficult computationally (e.g., expensive) for the process management system 206 to accurately determine how much of the shared memory 504 a particular worker is consuming. Further, in many embodiments, each of the workers 304a-304c could be utilizing different amounts of unique and shared memory. Accordingly, the process management system 206 may not be able to easily and/or efficiently determine which process is consuming larger portions of the shared memory 504.

As mentioned above, the process management system 206 can determine when to terminate one or more workers 304A-304c based on the memory utilization levels of the host device. To illustrate, FIG. 5B shows a depiction of the host memory 509 (e.g., physical memory on the host device). As shown, the host memory 509 can include the host memory amount 514 (shown as the shaded area), which includes the total memory utilized by all process on the host device. For instance, the utilized model memory 516 can represent the total amount of physical memory consumption of all the processes on the host device. In addition, the host memory 509 shows the utilized model memory 516 (shown as the patterned area), which includes the memory utilized by the pre-fork worker process model 500. For instance, the utilized model memory 516 can include the aggregate memory utilization of the unique memories 502, 506a-506c and the shared memory 504.

While the host memory amount 514 primarily refers to the amount of physical memory currently utilized on the host device by all processes, in some instances, the host memory amount 514 can refer to the amount of memory consumed by only the pre-fork worker process model 500 (and additional similar models in some instances). In many embodiments, the utilized model memory 516 is at or near the host memory amount 514 as the pre-fork worker process model 500 often utilizes the majority of the host device's physical memory.

As described above, the process management system 206 can identify the aggregate memory consumption of the pre-fork worker process model and/or other processes running on the host device (i.e., the host memory amount 514). For example, as described above, the process management system 206 retrieves the host memory amount 514 from the host device itself (e.g., via a background process call). Additionally, the process management system 206 can monitor the host memory amount to determine when it reaches one or more host memory thresholds.

To illustrate, FIG. 5B includes multiple host memory thresholds set by the process management system 206. In particular, FIG. 5B includes a lower bound memory threshold 510 and an upper bound memory threshold 512. As shown, the lower bound memory threshold 510 is set below the upper bound memory threshold 512. While FIG. 5B shows two host memory thresholds, the process management system 206 can set additional thresholds.

In various embodiments, the process management system 206 determines when the host memory amount 514 reaches (i.e., meets or exceeds) one or more of the host memory thresholds. Depending on a number of factors, such as a spike in incoming requests, the host memory amount 514 can quickly fluctuate. Thus, in some cases, the process management system 206 made determine that the host memory amount 514 reaches or satisfies the upper bound memory threshold at the same time as determining that the lower bound memory threshold is also satisfied.

Moreover, the process management system 206 can measure the host memory thresholds utilizing different parameters and/or values. For example, a host memory threshold can correspond to a percent or memory on the host device (e.g., 75% or 95% of available physical memory), or the total memory available on a host device (e.g., 16 GB of RAM). In another example, a host memory threshold can correspond to a portion (e.g., percent or amount) of memory allocated to the pre-fork worker process model 500. For example, the host memory threshold corresponds to a predetermined memory allocation on the host device (e.g., 5 GB) regardless of the memory size on the host device.

When the host memory amount reaches one of the host memory thresholds, the process management system 206 can begin terminating workers to reduce and/or maintain a stable level of memory consumption by the pre-fork worker process model. Indeed, by monitoring the overall memory consumption of the pre-fork worker process model and terminating workers when the host memory amount grows too large, the process management system 206 can prevent individual workers and/or the workers collectively from consuming fluctuating amounts of memory. Indeed, by stabilizing memory usage at the host device, the process management system 206 enables the host device to operate more efficiently and reliably.

As mentioned above, FIG. 6 corresponds to terminating worker processes. In particular, FIG. 6 illustrates a state diagram of a series of acts of determining when to terminate worker processes to free up memory on a host device in accordance with one or more embodiments. In various embodiments, the process management system 206 implements the series of acts included in FIG. 6.

As shown, the series of acts in FIG. 6 includes the act 602 of the process management system 206 checking the host memory amount. In one or more embodiments, the process management system 206 can obtain the host memory amount from the host device, as described above. In some embodiments, the process management system 206 can internally track and/or monitor the host memory amount.

Further, in some embodiments, the process management system 206 utilizes the master to determine the host memory amount. For example, the master of the pre-fork worker process model call and retrieves the host memory amount from the host device (e.g., the system and/or operating system of the host device). In alternative embodiments, the process management system 206 utilizes a function or component apart from the pre-fork worker process model to identify the host memory amount. For instance, a memory manager within the process management system 206 performs system calls to determine the host memory amount from the host device.

FIG. 6 also shows an act 604 of the process management system 206 of determining whether a lower bound memory threshold is met. In various embodiments, the lower bound memory threshold indicates when the pre-fork worker process model is beginning to consume too much memory on the host device, such that the process management system 206 should terminate at least one of the workers to free up memory and/or maintain memory stability across the pre-fork worker process model.

As shown, if the lower bound memory threshold is not met, the process management system 206 can return back to the act 602 of checking or monitoring the host memory amount being consumed on the host device. Otherwise, if the lower bound memory threshold is met, the process management system 206 can proceed to the act 606 of identifying the worker memory amount for each of the worker processes.

The series of acts can include the act 606 of the process management system 206 identifying the worker memory amount for each of the worker processes. For additional context, when identifying the host memory amount, the process management system 206 does not determine the worker memory amount for each of the workers. Indeed, performing a single operation to determine the host memory amount of the pre-fork worker process model is less computationally taxing than performing several operations to determine the worker memory amount of each worker. However, upon determining that the host memory amount has exceeded the lower bound memory threshold, the process management system 206 begins to identify one or more workers to terminate. Accordingly, upon determining that the host memory amount has exceeded the lower bound memory threshold, the process management system 206 can identify the worker memory amount for each of the worker processes, as shown in the act 606.

More particularly, in various embodiments, the process management system 206 determines the worker memory amount based on the RSS of each worker. As provided above, the RSS (i.e., resident set size) of a worker indicates the total memory consumption of the worker. Indeed, the RSS can include both the unique memory (e.g., USS) of the worker as well as the shared memory (e.g., PSS) shared by multiple workers and/or the master. For example, in one or more embodiments, each worker updates its RSS in a shared table using a background thread. Then, when the master process needs to terminate a certain number workers, the process management system 206 checks the shared table and selects the workers with the highest RSS.

Moreover, while the RSS can be less accurate when determining how much memory a worker is individually consuming, the RSS can server a reliable metric when relatively comparing workers to each other (e.g., comparing which worker consuming more memory). Further, in many embodiments, determining the RSS of a worker is computationally cheaper and/or faster than determining the PSS or the USS of the worker.

In alternative embodiments, the process management system 206 can employ different metrics to measure the worker memory amount of the workers. For example, the process management system 206 measures the USS (e.g., private or unique memory) or the PSS to determine worker memory amount. When the workers utilize shared memory, however, measuring the USS may result in less accurate results than measuring the RSS for each worker. However, if the workers only consumed unique memory or consumed unique memory first, the USS may prove to be a reliable measure. Indeed, different measuring metrics may yield more accurate results based on how memory is allocated to the workers.

In some embodiments, the process management system 206 determines the worker memory amount of each worker based on a set of metrics. For example, the process management system 206 can identify the RSS, USS, and PSS for each worker. Using these amounts, the process management system 206 can determine the actual memory consumption of each worker. While this approach often yields more accurate measures of worker memory amounts, it is much more computationally expensive than approaches described above (e.g., measuring the RSS). Further, when measuring the worker memory amount of each of the workers to determine their relative memory consumption (e.g., using the RSS alone), both approaches yield similar results.

In various embodiments, the process management system 206 orders and/or prioritizes the workers based on their worker memory amounts. For example, the process management system 206 lists the workers from highest to lowest with respect to memory consumption on the host device. In some embodiments, once the process management system 206 orders the workers based on their memory consumption, the process management system 206 can disregard the worker memory amounts determined for each worker, as these values are relative.

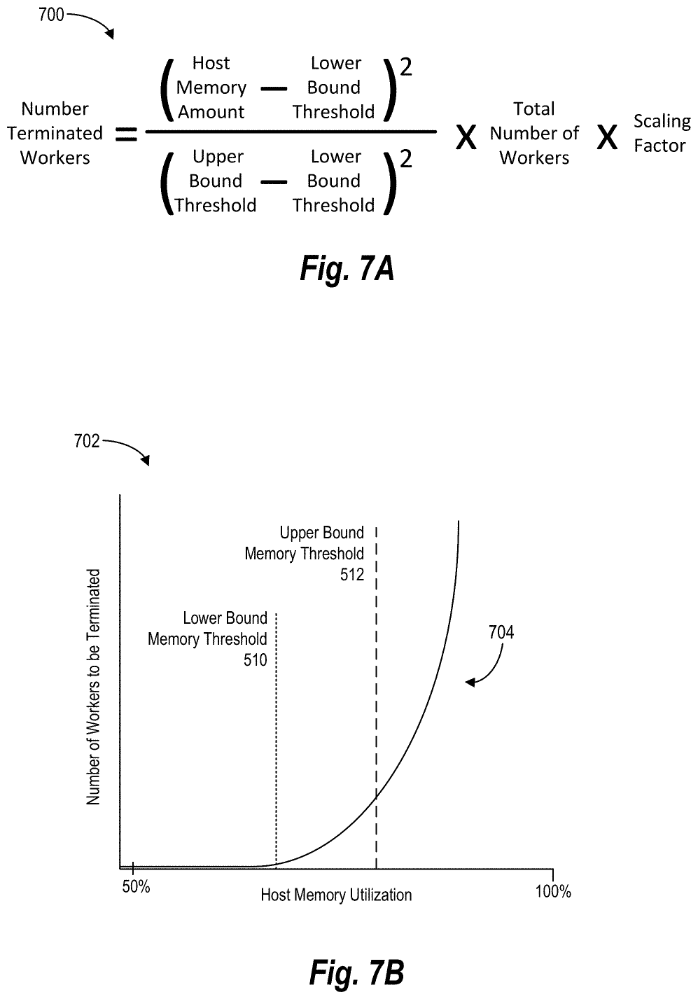

As shown in FIG. 6, the series of acts includes an act 608 of determining a number of workers to be terminated. Indeed, when the lower bound memory threshold is satisfied, the process management system 206 can terminate at one or more, workers to maintain stable memory consumption across the pre-fork worker process model. In one or more embodiments, the process management system 206 determines the number of workers to be terminated based on the host memory amount. For example, the process management system 206 generates a table that indicates the number of workers to be terminated based on the host memory amount. Additional detail regarding determining the number of workers to be terminated is provided below with respect to FIGS. 7A-7B.

Upon determining the number of workers to terminate and identifying which workers are consuming the most memory on the host device, the process management system 206 can identify the worker processes to be terminated, as shown in the act 610. For instance, in one or more embodiments, the process management system 206 can identify the workers consuming the most memory (e.g., having the highest worker memory amounts) to be terminated. For example, the process management system 206 selects the top x workers on the list of highest consumers, where x corresponds to the number of workers to be terminated. In this manner, the process management system 206 can arrive at the optimally level memory consumption for the pre-fork worker process model on the host device.

In various embodiments, the process management system 206 can determine how to terminate the workers to be terminated. Often, the manner of termination depends on the consumption level of the host memory amount across the pre-fork worker process model. To illustrate, the series of acts includes an act 612 of the process management system 206 determining whether an upper bound memory threshold is met. In many embodiments, the upper bound memory threshold indicates an excessive level of memory consumption, where further memory consumption could result in an out-of-memory (OOM) error on the host device, which causes numerous problems to both the pre-fork worker process model as well as other applications and system functions on the host device.

Accordingly, if the upper bound memory threshold is met, the process management system 206 can perform a brutal or evil termination of the workers identified to be terminated. To illustrate, the series of acts includes an act 614 of the process management system 206 sending an immediate termination signal to the workers identified to be terminated. In one or more embodiments, the process management system 206 sends a signal or a flag to the workers identified to be terminated indicating immediate termination. In response, these workers terminate their processes without completing the incoming requests they are currently handling.

Alternatively, if the upper bound memory threshold is not met, the process management system 206 can perform a graceful or natural termination of the workers identified to be terminated. To illustrate, the series of acts includes an act 616 of the process management system 206 sending a delay termination signal to the workers identified to be terminated. In one or more embodiments, the process management system 206 sends a signal or a flag to the workers identified to be terminated that indicates termination after completing its current incoming request and before picking up a new request. For example, upon a worker identifying a delay termination flag, the worker first performs clean up tasks in connection with terminating itself.

FIGS. 7A-7B illustrate graphics of determining when and how many worker processes to terminate on the host device in accordance with one or more embodiments. In particular, FIG. 7A provides an example algorithm 700 for determining an optimal number of worker processes to be terminated. FIG. 7B shows a graph corresponding to the results of one implementation of the example algorithm 700.

As shown, in FIG. 7A, the algorithm 700 corresponds to determining the number of worker processes to be terminated. As also shown, the algorithm 700 is based on the host memory amount, the lower bound memory threshold, the upper bound memory threshold, the total number of workers, and a scaling factor. In some embodiments, the algorithm 700 includes more or fewer factors. For example, the algorithm 700 may not include the scaling factor in one or more embodiments.

As another example, the algorithm 700 can include a constant. For instance, the algorithm 700 adds a one after the scaling factor (i.e., . . . Scaling Factor+1). In this manner, the constant serves as the minimum number of workers to terminate when the lower host bound memory is reached. Otherwise, when the host memory amount matches the lower bound memory threshold, the number of terminated workers could still equal zero (i.e., 0).

In various embodiments, the algorithm 700 is a non-linear, quadratic function that increases exponentially as the host memory amount increases. In this manner, the process management system 206 can utilize the algorithm 700 to ensure that the pre-fork worker process model terminates enough workers to prevent an OOM error on the host device. In alternative embodiments, the process management system 206 can employ a linear or another type of function to determine the number of worker processes to be terminated.

Stepping through the algorithm 700, the process management system 206 can determine the difference between the host memory amount and the lower bound memory threshold (i.e., the numerator) as well as the difference between the upper bound memory threshold and the lower bound memory threshold (i.e., the denominator). Further, the process management system 206 can divide the squares of these values to determine a worker termination factor. In most cases, the host memory amount will be less than the upper bound memory threshold. In these cases, the worker termination factor will be less than one (i.e., 1). However, in cases where the host memory amount is above the upper bound, the worker termination factor can be above one.

As shown, the process management system 206 can apply (e.g., multiply) the worker termination factor to the total number of workers as well as the scaling factor. In various embodiments, the scaling factor serves as a tuning parameter that can control the general number of workers. For example, a larger scaling factor indicates a more aggressive worker termination approach. In many embodiments, the scaling factor will be less than one or set to one. However, in select embodiments, the scaling factor can be above one.

In cases where the worker termination factor and/or the scaling factor are less than one, the process management system 206 can terminate less than all of the total number of workers. In a similar manner, when the worker termination factor and/or scaling factor is greater than one, the algorithm 700 can result in terminating a number of workers above the total number of workers. In these cases, the process management system 206 can terminate all active workers.

As mentioned above, the process management system 206 can generate a table that stores the number of workers to terminate for one or more host memory amounts. For example, the table provides the number of workers to terminate based on given values for the lower bound memory threshold, the upper bound memory threshold, the number of total workers, and/or the scaling factor. Often, one or more of these values are included in the configuration file associated with the pre-fork worker process model and/or default values.

To illustrate, for each host memory amount above the lower bound memory threshold, up to the upper bound memory threshold (or up to 100% of the host memory amount), the process management system 206 can determine the number of workers to be terminated and store the value in the table. In this manner, when the process management system 206 detects that the host memory amount reaches the lower bound memory threshold, the process management system 206 can look up the number of workers to be terminated in the table rather than having to calculate the number on the fly or perform a new calculation each time the lower bound memory threshold is satisfied.

As a brief example of the algorithm, given a lower bound memory threshold of 82% memory consumption on a host device, an upper bound memory threshold of 88% memory consumption on the host device, a total number of workers of 10, and a scaling factor of 0.75. With these given values, the process management system 206 determines to terminate one worker around 84% of the host memory amount is consumed, two workers around 85%, five workers around 87%, and all the workers when over 89% of the host memory amount is consumed. Indeed, the number of workers to be terminated increases exponentially as the host memory amount increases.

As mentioned above, FIG. 7B shows a graph 702 corresponding to the results of one implementation of the example algorithm 700. As shown, the graph 702 corresponds to the number of workers to be terminated (y-axis) relative to the percent of the host memory utilization amount being consumed on a host device (x-axis). As also shown, the graph 702 includes the lower bound memory threshold 510, the upper bound memory threshold 512, and the host memory amount 704.

As illustrated, as the host memory amount 704 increases up to the lower bound memory threshold, the number of workers to be terminated remains at zero. Upon the host memory amount 704 meeting the lower bound memory threshold (e.g., a first host memory threshold), the number of workers to be terminated beings to increase. Then, as the host memory amount 704 continues to increase, the number of workers to be terminated exponentially grows.

While FIGS. 4-7B corresponded to the process management system 206 related to improved memory management and stabilization of the host device, FIGS. 8A-8B and 9 relate to the process management system 206 performing adaptive respawning to improve resource utilization of a host device. In particular, FIGS. 8A-8B illustrate schematic diagrams of delaying terminated worker processes from respawning within the pre-fork worker process model in accordance with one or more embodiments.

As shown, FIG. 8A includes a pre-fork worker process model 800a that includes the master process 302 (or simply “master 302”) and multiple worker processes 304a-304d (or simply “workers 304a-304d”) introduced above in connection with FIG. 3A. In addition, the pre-fork worker process model 800a includes multiple terminated workers. For example, the pre-fork worker process model 800a shows that the process management system 206 has terminated the second worker 304b and the third worker 304c, similar to the updated pre-fork worker process model 300b described above in connection with FIG. 3B.

In one or more embodiments, the terminated workers are terminated by the process management system 206 based on the embodiments described above in connection with monitoring the host memory amount of the host device. However, in some embodiments, the process management system 206 utilizes alternative methods and techniques to terminate the worker processes. For example, the process management system 206 terminates a worker based on the worker exceeding a single worker memory threshold, as mentioned previously.

In some embodiments, the process management system 206 can respawn a worker upon the worker being terminated to maintain the number of workers indicated in the static configuration file associated with the pre-fork worker process model. However, immediately respawning the terminated worker can be computationally inefficient, particularly if the worker will remain idle upon being respawned. As detailed previously, maintaining idle workers not only ties up and wastes memory resources, but it can also cause computing problems on the host device. (e.g., higher process contentions, buffering issues, and polluting caches). Accordingly, both memory and computational gains can result in reducing the respawn rate of terminated workers.

In many embodiments, the process management system 206 implements adaptive respawning to reduce the respawn rate of terminated workers. To illustrate, FIG. 8B includes an updated pre-fork worker process model 800b where the process management system 206 has respawned one terminated worker and delayed termination of another terminated worker. In particular, as shown in the updated pre-fork worker process model 800b, the process management system 206 respawns the second worker 804b and delays respawning the third worker 304c after it has been terminated.

Additional detail regarding the process management system 206 implementing adaptive respawning will now be provided in connection with FIG. 9. In particular, FIG. 9 illustrates a state diagram of a series of acts 900 of adaptively restarting terminated worker processes in accordance with one or more embodiments. In one or more embodiments, the process management system 206 performs the series of acts 900.

As shown, the series of acts 900 includes an act 902 of the process management system 206 terminating a number of identified worker processes. As described previously, the process management system 206 can terminate one or more workers utilizing a variety of techniques and methods. For example, the process management system 206 (e.g., via the master process) sends a termination flag or other signal to a worker that instructs the worker to kill itself upon completing its current task (e.g., processing an incoming request).

The series of acts 900 also includes an act 904 of the process management system 206 determining whether the incoming requests are below an incoming queue threshold. For context, in one or more embodiments, the process management system 206 maintains an incoming request queue (e.g., a listening queue). For example, the process management system 206 utilizes the master process to monitor the size of a TCP connection backlog (i.e., the listening queue) to determine the number of incoming requests waiting to be processed. Requests in the incoming queue indicate requests waiting to be fulfilled by the process management system 206.

Further, upon identifying the number of incoming requests on the incoming queue, the process management system 206 can determine whether the number of incoming requests are at or below an incoming queue threshold. For example, if the incoming queue threshold is 5, the process management system 206 determines if five or more requests are waiting in the incoming queue (e.g., the listening queue). If the incoming queue threshold is satisfied (e.g., there are less than five requests in the incoming queue), the process management system 206 can proceed to the act 906. Otherwise, the process management system 206 can proceed to the act 910.

As shown, the series of acts 900 includes the act 906 of the process management system 206 determining whether a threshold number of idle worker processes are available. As mentioned above, idle workers can be redundant and utilize resources of the host device while providing little or no benefits to the host device. Accordingly, the act 906 can include the process management system 206 identifying the number of workers of the pre-fork worker process model that are not currently handling an incoming request (i.e., idle workers).

Further, the act 906 can include the process management system 206 of comparing the number of idle workers to an idle worker threshold amount. For example, if the idle worker threshold is 3, the process management system 206 determines if the pre-fork worker process model includes at least three idle workers. In some embodiments, the idle worker threshold corresponds to a number of idle workers (e.g., 2, 5, or 10 idle workers). In alternative embodiments, the idle worker threshold corresponds to a percentage of total worker threshold (e.g., 20%, 40%, or 75% of the total workers).

If the process management system 206 determines that the idle worker threshold is satisfied, the process management system 206 can proceed to the act 908. For example, the process management system 206 identifies that the pre-fork worker process model includes three idle workers, which satisfies the idle worker threshold of three. Otherwise, if the number of idle workers is less than the idle worker threshold, the process management system 206 can proceed to the act 910.

As shown, the series of acts 900 includes the act 908 of the process management system 206 delaying respawning the terminated worker processes. For example, in one or more embodiments, upon determining that the pre-fork worker process model includes an ample number of idle workers and that the incoming queue is empty or nearly empty, the process management system 206 can prevent the master (i.e., master process) from immediately respawning a terminated worker. Additionally, in some embodiments, the adds the terminated worker (e.g., a PID of the terminated worker) to a list or queue of terminated workers waiting to be respawned.

In various embodiments, the process management system 206 can delay respawning a terminated worker upon either the number of incoming requests being below the incoming queue threshold, the number of idle workers being below the idle worker threshold, or another condition being satisfied. In some embodiments, the process management system 206 delays respawning when the number of idle workers is equal or greater than the number of incoming requests in the incoming queue.

As shown in FIG. 9, the process management system 206 can return to the act 904 and/or the act 906 upon delaying respawning a terminated worker. In this manner, as the number of incoming requests grow and/or the number of idle workers reduces, the process management system 206 can begin to respawn terminated workers, as described below in connection with the act 910. Otherwise, the process management system 206 can continue to delay respawning terminated workers until they are needed.

As mentioned above, the series of acts 900 includes the act 910 of the process management system 206 respawning a terminated worker process. In particular, the process management system 206 determines that an additional worker is needed due to the number of incoming requests growing, the number of idle workers falling, or for another reason (e.g., to maintain a minimum number of workers). Accordingly, the process management system 206 can respawn one or more of the terminated workers. For context, in respawning a terminated worker, the process management system 206 often reuses its same process identifier (e.g., PID) previously allocated to the terminated worker.

Further, the series of acts 900 includes an act 912 of the process management system 206 assigning an incoming request to the respawned worker process. For example, in one or more embodiments, the process management system 206 assigns an incoming request from the incoming queue (e.g., listening queue) to the respawned worker. In some embodiments, the respawned worker remains idle for a short time waiting for an incoming request to arrive, which the process management system 206 assigns to the newly respawned worker.

In various embodiments, the process management system 206 respawns one terminated worker, even if multiple terminated workers are present. In particular, the process management system 206 can respawn a terminated worker, assign the worker to an incoming request, then return to the act 904 and/or the act 906 to determine whether to respawn an additional terminated worker. Indeed, each time a terminated worker is respawned, the process management system 206 can determine whether the incoming request threshold and/or the idle worker threshold are satisfied. If so, the process management system 206 can delay respawning additional terminated workers (i.e., the act 908). Otherwise, the process management system 206 can respawn an additional worker (i.e., the act 910).

In alternative embodiments, the process management system 206 can respawn multiple terminated workers in connection with the act 910. For example, the process management system 206 determines that multiple workers need to be respawned to meet (or exceed) the minimum number of idle workers (e.g., the idle worker threshold) and/or to process multiple requests sitting in the incoming queue. In these embodiments, the act 912 can include assigning one or more of the respawned workers to incoming requests, as described above.

Moreover, in various embodiments, the act 910 can include respawning terminated workers up to a predetermined worker respawn limit. In some embodiments, the worker respawn limit matches the maximum number of workers set for the pre-fork worker process model (e.g., as defined in the configuration file). In alternative embodiments, the worker respawn limit is less than the maximum number of workers. For example, the process management system 206 can only adaptively respawn workers that have been terminated, and thus, is unable to create more workers than previously existed in the pre-fork worker process model, whether the number be the maximum number of workers or a lesser number of workers (e.g., the process management system 206 has not yet forked the maximum number of workers).

As described above, the adaptive respawning process described in connection with the series of acts 900 provides a number of benefits over conventional systems. For example, the adaptive respawning process avoids unnecessary worker respawns, which is computationally expensive. Further, the adaptive respawning process reduces computational costs related to maintaining idle workers. In addition, as described above, the adaptive respawning process enables the process management system 206 to remove some variation (e.g., spikes) in the host memory utilization, which results in improved reliability and functionality of the host device.

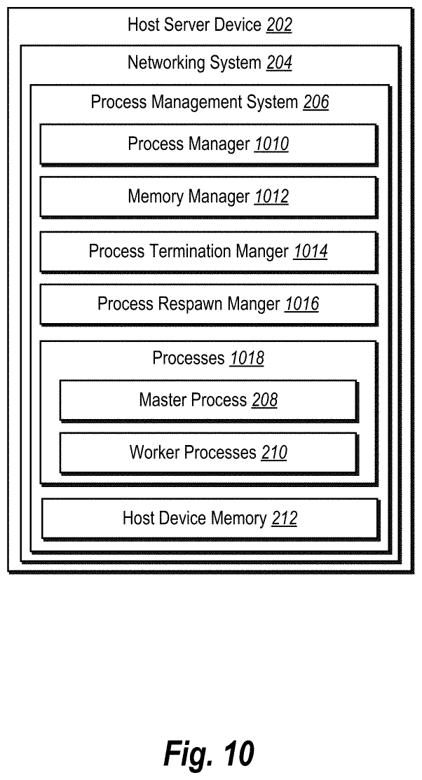

Turning now to FIG. 10, additional detail is provided regarding the components and capabilities of the process management system 206 in accordance with one or more embodiments. As shown, the process management system 206 is implemented by the host device 202. In other embodiments, the components of the process management system 206 can be implemented across multiple computing devices, such as over multiple host devices, over the host device 202 and the user client device 214a, and/or other devices not shown.

FIG. 10 shows the host device 202, as introduced above with respect to FIG. 2. The host device 202 includes the networking system 204 having the process management system 206 and the host device memory 212, each of which is described above in connection with FIG. 2. As also shown, the process management system 206 includes a process manager 1010, a memory manager 1012, a process termination manager 1014, a process respawn manager 1016, and processes 1018. Additional detail regarding each of the components 1002-1018 will be provided in turn.

As shown, the process management system 206 includes the process manager 1010. In various embodiments, the process manager 1010 can initiate, execute, run, fork, allocate, command, modify, and/or terminate the processes 1018 of a pre-fork worker process model. For example, the process manager 1010 can load a master process 208 (or “master 208”) onto the host device 202 and fork one or more worker processes 210 (or “workers 210”). Further, the process manager 1010 can maintain worker statistics, such as the number of active workers, idle workers, terminated workers, respawned workers, and other types of workers, as described above.

In additional embodiments, the process manager 1010 can receive, identify, monitor, assign, allocate, modify, and/or terminate requests. For example, the process manager 1010 can monitor an incoming queue of requests (e.g., a listening queue) to determine the number of incoming requests waiting to be processed by workers and to determine whether to fork additional workers to handle incoming requests, as described above.

As shown, the process management system 206 includes the memory manager 1012. In one or more embodiments, the memory manager 1012 can identify, determine, monitor, call, report, allocate, calculate, and/or share memory and memory consumption among the processes 1018. For example, the memory manager 1012 identifies the memory consumption of the pre-fork worker process model based on the shared memory of the master 208 and/or the workers 210 (i.e., the host memory amount), as described above. In addition, the memory manager 1012 can determine the memory consumption of each of the workers 210 (e.g., the RSS, PSS, and/or USS), as described above.

As shown, the process management system 206 includes the process termination manager 1014. In one or more embodiments, the process termination manager 1014 can determine to terminate, signal, flag, force terminate, kill, end, quit, and/or cause to terminate one or more workers 210. For example, in one or more embodiments, the process termination manager 1014 determines when the host memory amount of the pre-fork worker process model exceeds a host memory threshold (e.g., a lower bound memory threshold and/or an upper bound memory threshold), as described above. In addition, the process termination manager 1014 can determine how many workers to terminate, which workers 210 to terminate, and/or how to terminate workers identified to be terminated (e.g., gracefully or brutally), as described above.

As shown, the process management system 206 includes the process respawn manager 1016. In various embodiments, the process respawn manager 1016 can respawn or delay respawning one or more workers 210 (e.g., workers 210 that are terminated). For instance, in one or more embodiments, the process respawn manager 1016 monitors various conditions, triggers, metrics, and/or thresholds of the pre-fork worker process model to determine when to respawn one or more terminated workers and when to delay, as described above. For example, the process respawn manager 1016 delays respawning a terminated worker based on an incoming queue threshold and the idle worker threshold being satisfied, as described previously.

The components 1002-1018 can include software, hardware, or both. For example, the components 1002-1018 include one or more instructions stored on a computer-readable storage medium and executable by processors of one or more computing devices, such as a client device or server device. When executed by the one or more processors, the computer-executable instructions of the host device 202, the networking system 204, and/or the process management system 206 can cause the computing device(s) to perform the feature learning methods described herein. Alternatively, the components 1002-1018 can include hardware, such as a special-purpose processing device to perform a certain function or group of functions. Alternatively, the components 1002-1018 can include a combination of computer-executable instructions and hardware.

Furthermore, the components 1002-1018 are, for example, implemented as one or more operating systems, stand-alone applications, modules of an application, plug-ins, library functions or functions called by other applications, and/or as a cloud computing model. Thus, the components 1002-1018 can be implemented as one or more web-based applications hosted on a remote server. Furthermore, the components 1002-1018 can be implemented as a stand-alone application, such as a desktop or mobile application. The components 1002-1018 can also be implemented in a suite of mobile device applications or “apps.” To illustrate, the components 1010-1018 may be implemented in a host server device that provides services and/or digital content in connect with, but not limited to INSTAGRAM or FACEBOOK.

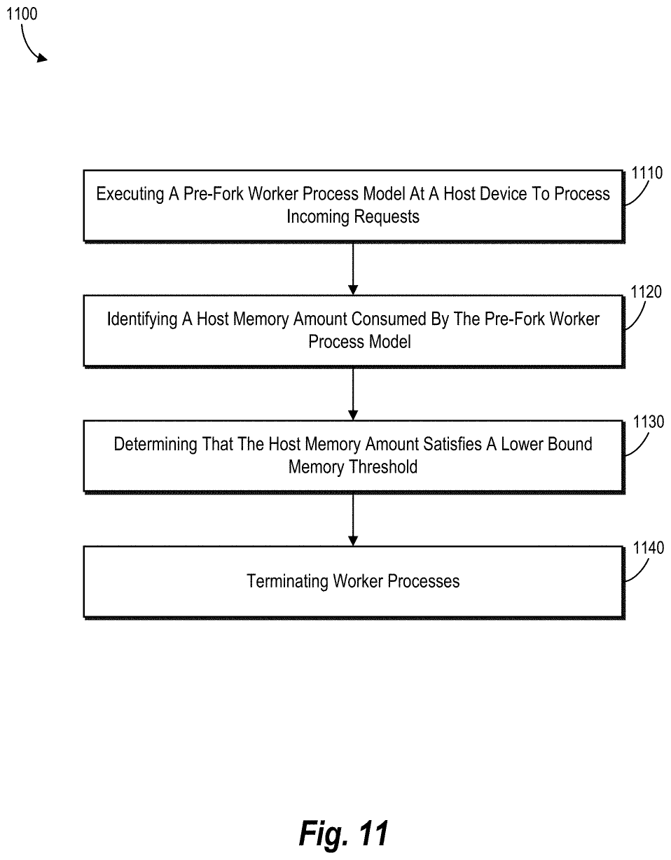

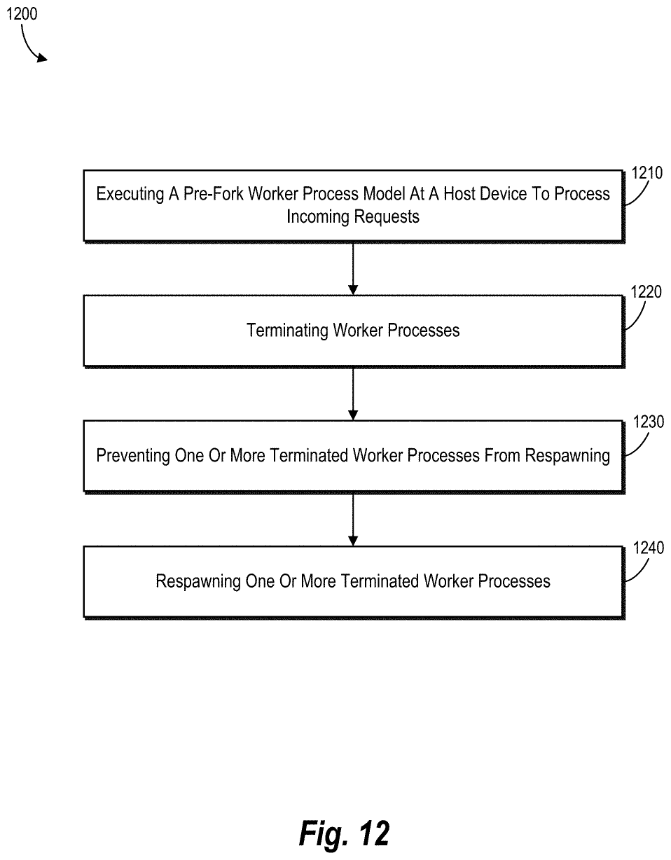

FIGS. 1-10, the corresponding text, and the examples provide several different systems, methods, techniques, components, and/or devices of the process management system 206 in accordance with one or more embodiments. In addition to the above description, one or more embodiments can also be described in terms of flowcharts, including acts for accomplishing a particular result. For example, FIG. 11 and FIG. 12 illustrate flowcharts of example sequences of acts in accordance with one or more embodiments. In addition, each of the acts in FIG. 11 and FIG. 12 may be performed with more or fewer acts. Further, the acts may be performed in differing orders. Additionally, the acts described herein may be repeated or performed in parallel with one another or parallel with different instances of the same or similar acts.

While FIG. 11 and FIG. 12 each illustrates a series of acts according to particular embodiments, alternative embodiments may omit, add to, reorder, and/or modify any of the acts shown. The series of acts of FIG. 11 and FIG. 12 can each be performed as part of a method. Alternatively, a non-transitory computer-readable medium can comprise instructions, when executed by one or more processors, cause a computing device (e.g., a client device and/or a server device) to perform the series of acts of FIG. 11 and/or FIG. 12. In still further embodiments, a system performs the acts of FIG. 11 and/or FIG. 12.

To illustrate, FIG. 11 shows a flowchart of a series of acts 1100 of improving memory management within a pre-fork worker process model in accordance with one or more embodiments. As shown, the series of acts 1100 includes the act 1110 of executing a pre-fork worker process model at a host device to process incoming requests. In particular, the act 1110 can include executing, at a host computing device, a pre-fork worker process model to process incoming requests, the pre-fork worker process model including a plurality of worker processes. In one or more embodiments, the act 1110 can include forking the plurality of worker processes at the host device prior to receiving incoming requests. In some embodiments, each of the plurality of worker processes handles an incoming request until the request is complete. The worker process can then handle a new incoming request generated by client devices associated with users requesting services or digital content.

As shown, the series of acts 1100 also includes the act 1120 of identifying a host memory amount consumed by the pre-fork worker process model. In particular, the act 1120 can include identifying a host memory amount corresponding to the memory utilized across the pre-fork worker process model at the host computing device. In one or more embodiments, the act 1120 can include performing a system call to the host device to determine the host memory amount. In various embodiments, the host memory amount comprises the amount of consumed shared memory (e.g., consumed physical memory). In alternative embodiments, the host memory amount comprises the memory consumed by both the master process and the plurality of worker processes. In various embodiments, the host memory amount corresponds to an amount of RAM consumed on the host device.

As shown, the series of acts 1100 can further include an act 1130 of determining that the host memory amount satisfies a lower bound memory threshold. In one or more embodiments, the act 1130 can include determining a worker memory amount for each of the plurality of worker processes. In additional embodiments, the worker memory amount for each of the plurality of worker processes includes a shared memory sized shared with a master process and a unique memory size not shared with the master process.

Additionally, the series of acts 110 can include an act 1140 of terminating worker processes. In particular, the act 1140 can include terminating one or more worker processes of the plurality of worker processes based on the lower bound memory threshold being satisfied. In one or more embodiments, the act 1140 can include determining the number of worker processes to terminate based on the host memory amount. In various embodiments, the act 1140 can include determining the one or more worker processes to terminate based on the one or more worker processes having a worker memory amount above a worker process memory threshold.

Further, the act 1140 can include assigning the number of worker processes having the highest worker memory amounts of the plurality of worker processes as the one or more worker processes to terminate. In some embodiments, the act 1140 can also include determining the number of worker processes based on the host memory amount, the lower bound memory threshold, an upper bound memory threshold, and a total number of worker processes. For example, in some embodiments, the act 1140 can also include utilizing a quadratic algorithm including the lower bound memory threshold, the upper bound memory threshold, the total number of worker processes, and a scaling factor to determine the number of worker processes to terminate.

In one or more embodiments, the act 1140 can include terminating the one or more worker processes by providing a termination signal to the one or more worker processes. For example, in additional embodiments, the termination signal causes the one or more worker processes to terminate upon completing a current task. In alternative embodiments, the termination signal causes the one or more worker processes to terminate immediately upon receiving the termination signal.

Further, in some embodiments, the act 1140 of terminating the one or more workers does not cause the one or more worker processes to respawn without a respawn signal. In some embodiments, the act 1140 can also include providing a respawn signal to one of the one or more worker processes to respawn within the pre-fork worker process model.

Turning now to the next figure, FIG. 12 shows a flowchart of a series of acts 1200 of adaptively restarting terminated worker processes in a pre-fork worker process model in accordance with one or more embodiments. As shown, the series of acts 1200 includes an act 1210 of executing a pre-fork worker process model at a host device to process incoming requests. In particular, the act 1210 can include executing, at a host computing device, a pre-fork worker process model to process incoming requests, the pre-fork worker process model including a plurality of worker processes. In one or more embodiments, the act 1210 can include forking the plurality of worker processes at the host device prior to receiving incoming requests. In some embodiments, each of the plurality of worker processes handles an incoming request until the request is complete. The worker process can then handle a new incoming request generated by client devices associated with users requesting services or digital content.

As shown, the series of acts 1200 also includes the act 1220 of terminating worker processes. In particular, the act 1220 can include terminating one or more worker processes. In one or more embodiments, the act 1220 includes terminating the one or more worker processes by providing a termination signal to the one or more worker processes. For example, in some embodiments, the termination signal causes the one or more worker processes to terminate upon completing a current task. In alternative embodiments, the termination signal causes the one or more worker processes to terminate immediately upon receiving the termination signal.

As shown, the series of acts 1200 can further include an act 1230 of preventing one or more terminated worker processes from respawning. In one or more embodiments, the act 1230 can include preventing, while an incoming queue threshold and an idle worker threshold are satisfied, the one or more terminated worker processes from respawning within the pre-fork worker process model. In one or more embodiments, the incoming queue threshold and the idle worker threshold are not satisfied when either the incoming queue threshold is not satisfied or the idle worker threshold is not satisfied. In some embodiments, the incoming queue threshold is satisfied when a number of incoming external requests is at or above the incoming queue threshold. In various embodiments, the idle worker threshold is satisfied when a number of idle worker processes is at or below the idle worker threshold.

Additionally, the series of acts 120 can include an act 1240 of respawning the one or more terminated worker processes. In one or more embodiments, the act 1240 can include respawning, while the incoming queue threshold and the idle worker threshold are not satisfied, the one or more terminated worker processes within the pre-fork worker process model. In one or more embodiments, the act 1240 includes respawning a first worker process of the one or more terminated worker processes and/or determining that the incoming queue threshold and the idle worker threshold are still not satisfied before respawning a second worker process of the one or more terminated worker processes

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of an example computing device 1300 that may be configured to perform one or more of the processes described above. One will appreciate the computing device 1300 may represent one or more computing devices (e.g., the host device 202) that can implement the process management system 206. As shown by FIG. 13, the computing device 1300 can comprise a processor 1302, a memory 1304, a storage device 1306, an I/O interface 1308, and a communication interface 1310, which may be communicatively coupled by way of a communication infrastructure 1312. While an example computing device 1300 is shown in FIG. 13, the components illustrated in FIG. 13 are not intended to be limiting. Additional or alternative components may be used in other embodiments. Furthermore, in certain embodiments, the computing device 1300 can include fewer components than those shown in FIG. 13. Components of the computing device 1300 shown in FIG. 13 will now be described in additional detail.

In one or more embodiments, the processor 1302 includes hardware for executing instructions, such as those making up a computer program. For example, to execute instructions, the processor 1302 may retrieve (or fetch) the instructions from an internal register, an internal cache, the memory 1304, or the storage device 1306 and decode and execute them. In one or more embodiments, the processor 1302 may include one or more internal caches for data, instructions, or addresses. For example, the processor 1302 may include one or more instruction caches, one or more data caches, and one or more translation lookaside buffers (TLBs). Instructions in the instruction caches may be copies of instructions in the memory 1304 or the storage device 1306.

The memory 1304 may be used for storing data, metadata, and programs for execution by the processor(s). The memory 1304 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 1304 may be internal or distributed memory.

The storage device 1306 includes storage for storing data or instructions. For example, storage device 1306 can comprise a non-transitory storage medium described above. The storage device 1306 may include a hard disk drive (HDD), a floppy disk drive, flash memory, an optical disc, a magneto-optical disc, magnetic tape, or a Universal Serial Bus (USB) drive or a combination of two or more of these. The storage device 1306 may include removable or non-removable (or fixed) media, where appropriate. The storage device 1306 may be internal or external to the computing device 1300. In one or more embodiments, the storage device 1306 is non-volatile, solid-state memory. In other embodiments, the storage device 1306 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 1308 allows a user to provide input to, receive output from, and otherwise transfer data to and receive data from computing device 1300. The I/O interface 1308 may include a mouse, a keypad or a keyboard, a touch screen, a camera, an optical scanner, network interface, modem, another known I/O devices or a combination of such I/O interfaces. The I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1308 is configured to provide graphical data to a display for presentation to a user. The graphical data may be representative of one or more graphical user interfaces and/or any other graphical content as may serve a particular implementation.

The communication interface 1310 can include hardware, software, or both. In any event, the communication interface 1310 can provide one or more interfaces for communication (e.g., packet-based communication) between the computing device 1300 and one or more other computing devices or networks. For example, the communication interface 1310 may include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 1310 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 1310 may facilitate communications with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination thereof.

Additionally, the communication interface 1310 may facilitate communications across various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1312 may include hardware, software, or both that connects components of the computing device 1300 to each other. For example, the communication infrastructure 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the process management system 206 can operate as a social networking system in various embodiments. In addition to the description given above, a social networking system may enable its users (such as persons or organizations) to interact with the system and with each other. The social networking system may, with input from a user, create and store in the social networking system a user profile associated with the user. The user profile may include demographic information, communication-channel information, and information on personal interests of the user. The social networking system may also, with input from a user, create and store a record of relationships of the user with other users of the social networking system, as well as provide services (e.g., wall posts, photo-sharing, online calendars and event organization, messaging, games, or advertisements) to facilitate social interaction between or among users.

Also, the social networking system may allow users to post photographs and other multimedia content items to a user's profile page (typically known as “wall posts” or “timeline posts”) or in a photo album, both of which may be accessible to other users of the social networking system depending upon the user's configured privacy settings.

FIG. 14 illustrates an example network environment 1400 of a networking system. The network environment 1400 includes a networking system 1402 having the process management system 206 (described previously), a client device 1406, and a third-party system 1408 connected to each other by a network 1404. Although FIG. 14 illustrates a particular arrangement of the networking system 1402, the client device 1406, the third-party system 1408, and the network 1404, this disclosure contemplates any suitable arrangement of the devices, systems, and networks. For example, the client device 1406 and the networking system 1402 may be physically or logically co-located with each other in whole, or in part. Moreover, although FIG. 14 illustrates a single client device 1406, the networking system 1402, the third-party system 1408, and the network 1404, this disclosure contemplates any suitable number of devices, systems, and networks.

This disclosure contemplates any suitable network. For example, one or more portions of the network 1404 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. The network 1404 may include one or more networks.

Links may connect the networking system 1402, the client device 1406, and the third-party system 1408 to the network 1404 or to each other. In particular embodiments, one or more links include one or more wireline (e.g., Digital Subscriber Line (DSL) or Data Over Cable Service Interface Specification (DOCSIS)), wireless (e.g., Wi-Fi or Worldwide Interoperability for Microwave Access (WiMAX)), or optical (e.g., Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1400. One or more first links may differ in one or more respects from one or more second links.

In particular embodiments, the client device 1406 may be an electronic device including hardware, software, or embedded logic components or a combination of two or more such components and capable of carrying out the appropriate functionalities implemented or supported by the client device 1406. For example, the client device 1406 may include any of the computing devices discussed above in relation to FIG. 13. The client device 1406 may enable a network user to access the network 1404. The client device 1406 may enable its user to communicate with other users associated with other client devices.

In particular embodiments, the client device 1406 may include a web browser, such as MICROSOFT INTERNET EXPLORER, GOOGLE CHROME, MOZILLA FIREFOX, APPLE SAFARI, and may have one or more add-ons, plug-ins, or other extensions (e.g., toolbars). A user at the client device 1406 may enter a Uniform Resource Locator (URL) or other address directing the web browser to a particular server (such as server, or a server associated with the third-party system 1408), and the web browser may generate a Hypertext Transfer Protocol (HTTP) request and communicate the HTTP request to server. The server may accept the HTTP request and communicate to the client device 1406 one or more Hypertext Markup Language (HTML) files responsive to the HTTP request.

The client device 1406 may render a webpage based on the HTML files from the server for presentation to the user. For example, webpages may render from HTML files, Extensible Hypertext Markup Language (XHTML) files, or Extensible Markup Language (XML) files, according to particular needs. Such pages may also execute scripts such as those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the networking system 1402 may be a network-addressable computing system that can host an online network of users (e.g., a social networking system or an electronic messaging system). In some embodiments, such as the illustrated embodiment, the networking system 1402 implements the process management system 206.

The networking system 1402 may generate, store, receive, and send networking data, such as user-profile data, concept-profile data, graph information (e.g., social-graph information), or other suitable data related to the online network of users. The networking system 1402 may be accessed by the other components of network environment 1400 either directly or via the network 1404. In particular embodiments, the networking system 1402 may include one or more servers. Each server may be a unitary server or a distributed server spanning multiple computers or multiple datacenters. Servers may be of various types, such as web server, news server, mail server, message server, advertising server, file server, application server, exchange server, database server, proxy server, another server suitable for performing functions or processes described herein, or any combination thereof.

In one or more embodiments, each server may include hardware, software, or embedded logic components or a combination of two or more such components for carrying out the appropriate functionalities implemented or supported by a server. In particular embodiments, the networking system 1402 may include one or more data stores. Data stores may be used to store various types of information. In particular embodiments, the information stored in data stores may be organized according to specific data structures. In particular embodiments, each data store may be a relational, columnar, correlation, or another suitable database. Although this disclosure describes or illustrates particular types of databases, this disclosure contemplates any suitable types of databases. Particular embodiments may provide interfaces that enable the networking system 1402, the client device 1406, or the third-party system 1408 to manage, retrieve, modify, add, or delete, the information stored in a data store.

In particular embodiments, the networking system 1402 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. The networking system 1402 may provide users of the online network of users the ability to communicate and interact with other users. In particular embodiments, users may join the online network of users via the networking system 1402 and then add connections (e.g., relationships) to a number of other users of the networking system 1402 whom they want to be connected to. Herein, the term “friend” may refer to any other user of the networking system 1402 with whom a user has formed a connection, association, or relationship via the networking system 1402.

In particular embodiments, the networking system 1402 may provide users with the ability to take actions on various types of items or objects, supported by the networking system 1402. For example, the items and objects may include groups or social networks to which users of the networking system 1402 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the networking system 1402 or by an external system of the third-party system 1408, which is separate from the networking system 1402 and coupled to the networking system 1402 via the network 1404.

In particular embodiments, the networking system 1402 may be capable of linking a variety of entities. For example, the networking system 1402 may enable users to interact with each other as well as receive content from the third-party systems 1408 or other entities, or to allow users to interact with these entities through an application programming interfaces (API) or other communication channels.

In particular embodiments, the third-party system 1408 may include one or more types of servers, one or more data stores, one or more interfaces, including but not limited to APIs, one or more web services, one or more content sources, one or more networks, or any other suitable components, e.g., that servers may communicate with. The third-party system 1408 may be operated by a different entity from an entity operating the networking system 1402. In particular embodiments, however, the networking system 1402 and the third-party systems 1408 may operate in conjunction with each other to provide social networking services to users of the networking system 1402 or the third-party systems 1408. In this sense, the networking system 1402 may provide a platform, or backbone, which other systems, such as the third-party systems 1408, may use to provide social networking services and functionality to users across the Internet.

In particular embodiments, the third-party system 1408 may include a third-party content object provider. A third-party content object provider may include one or more sources of content objects, which may be communicated to a client device 1406. For example, content objects may include information regarding things or activities of interest to the user, such as movie showtimes, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the networking system 1402 also includes user-generated content objects, which may enhance a user's interactions with the networking system 1402. User-generated content may include anything a user can add, upload, send, or “post” to the networking system 1402. For example, a user communicates posts to the networking system 1402 from a client device 1406. Posts may include data such as status updates or other textual data, location information, photos, videos, links, music or other similar data or media. Content may also be added to the networking system 1402 by a third-party through a “communication channel,” such as a newsfeed or stream.

In particular embodiments, the networking system 1402 may include a variety of servers, sub-systems, programs, modules, logs, and data stores. In particular embodiments, the networking system 1402 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store.

The networking system 1402 may also include suitable components such as network interfaces, security mechanisms, load balancers, failover servers, management-and-network-operations consoles, other suitable components, or any suitable combination thereof. In particular embodiments, the networking system 1402 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. For example, if a user “likes” an article about a brand of shoes the category may be the brand, or the general category of “shoes” or “clothing.”

A connection store may be used for storing connection information about users. The connection information may indicate users who have similar or common work experience, group memberships, hobbies, educational history, or are in any way related or share common attributes. The connection information may also include user-defined connections between different users and content (both internal and external).

A web server may be used for linking the networking system 1402 to one or more client device 1406 or one or more the third-party system 1408 via the network 1404. The web server may include a mail server or other messaging functionality for receiving and routing messages between the networking system 1402 and one or more client device 1406.

An API-request server may allow the third-party system 1408 to access information from the networking system 1402 by calling one or more APIs. An action logger may be used to receive communications from a web server about a user's actions on or off networking system 1402. In conjunction with the action log, a third-party-content-object log may be maintained of user exposures to third-party-content objects. A notification controller may provide information regarding content objects to a client device 1406. Information may be pushed to a client device 1406 as notifications, or information may be pulled from client device 1406 responsive to a request received from client device 1406.

Authorization servers may be used to enforce one or more privacy settings of the users of the networking system 1402. A privacy setting of a user determines how particular information associated with a user can be shared. The authorization server may allow users to opt in to or opt out of having their actions logged by the networking system 1402 or shared with other systems (e.g., the third-party system 1408), such as by setting appropriate privacy settings. Third-party-content-object stores may be used to store content objects received from third parties, such as the third-party system 1408. Location stores may be used for storing location information received from client device 1406 associated with users. Advertisement-pricing modules may combine social information, the current time, location information, or other suitable information to provide relevant advertisements, in the form of notifications, to a user.

The foregoing specification is described with reference to specific example embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
executing, by at least one processor of a host computing device, a pre-fork worker process model to process incoming requests, the pre-fork worker process model comprising a plurality of worker processes;
identifying a host memory amount corresponding to memory utilized across the pre-fork worker process model at the host computing device;
determining that the host memory amount satisfies a lower bound memory threshold; and
based on the lower bound memory threshold being satisfied, terminating one or more worker processes of the plurality of worker processes.

2. The computer-implemented method of claim 1, further comprising determining a worker memory amount for each of the plurality of worker processes.

3. The computer-implemented method of claim 2, further comprising assigning a number of worker processes having highest worker memory amounts of the plurality of worker processes as the one or more worker processes to terminate.

4. The computer-implemented method of claim 3, further comprising determining the number of worker processes based on the host memory amount, the lower bound memory threshold, an upper bound memory threshold, and a total number of worker processes.

5. The computer-implemented method of claim 4, further comprising utilizing a quadratic algorithm comprising the lower bound memory threshold, the upper bound memory threshold, the total number of worker processes, and a scaling factor to determine the number of worker processes to terminate.

6. The computer-implemented method of claim 2, further comprising determining the one or more worker processes to terminate based on the one or more worker processes having a worker memory amount above a worker process memory threshold.

7. The computer-implemented method of claim 2, wherein the worker memory amount for each of the plurality of worker processes comprises a shared memory sized shared with a master process and a unique memory size not shared with the master process.

8. The computer-implemented method of claim 1, further comprising providing a termination signal to the one or more worker processes to terminate the one or more worker processes.

9. The computer-implemented method of claim 8, wherein the termination signal causes the one or more worker processes to terminate upon completing a current task.

10. The computer-implemented method of claim 8, wherein the termination signal causes the one or more worker processes to terminate upon receiving the termination signal.

11. The computer-implemented method of claim 8, wherein terminating the one or more worker processes does not cause the one or more worker processes to respawn until a respawn signal is received.

12. The computer-implemented method of claim 11, further comprising providing the respawn signal to one of the one or more worker processes to respawn within the pre-fork worker process model.

13. A system for automatically selecting objects within digital images comprising:
at least one processor; and
at least one non-transitory computer-readable storage medium storing instructions that, when executed by the at least one processor, cause the system to:
execute, on a host computing device, a pre-fork worker process model to process incoming requests, the pre-fork worker process model comprising a plurality of worker processes;
identify a host memory amount corresponding to memory utilized across the pre-fork worker process model at the host computing device;
determine that the host memory amount satisfies a lower bound memory threshold; and
based on the lower bound memory threshold being satisfied, terminate one or more worker processes of the plurality of worker processes.

14. The system of claim 13, further comprising instructions that cause the system to:
prevent, while an incoming queue threshold and an idle worker threshold are satisfied, the one or more terminated worker processes from respawning within the pre-fork worker process model; and
respawn, while the incoming queue threshold and the idle worker threshold are not satisfied, a terminated worker process of the one or more terminated worker processes within the pre-fork worker process model.

15. The system of claim 14, wherein the incoming queue threshold and the idle worker threshold are not satisfied when either the incoming queue threshold is not satisfied or the idle worker threshold is not satisfied.

16. The system of claim 14, wherein the incoming queue threshold is satisfied when a number of incoming requests are at or above the incoming queue threshold.

17. The system of claim 14, wherein the idle worker threshold is satisfied when a number of idle worker processes is at or below the idle worker threshold.

18. The system of claim 14, wherein respawning the one or more terminated worker processes comprises:
respawning a first worker process of the one or more terminated worker processes; and
determining that the incoming queue threshold and the idle worker threshold are still not satisfied before respawning a second worker process of the one or more terminated worker processes.

19. A non-transitory computer-readable medium storing instructions that, when executed by at least one processor, cause a computer system to:
execute, on a host computing device, a pre-fork worker process model to process incoming requests, the pre-fork worker process model comprising a plurality of worker processes;
identify a host memory amount corresponding to memory utilized across the pre-fork worker process model at the host computing device;
determine that the host memory amount satisfies a lower bound memory threshold; and
based on the lower bound memory threshold being satisfied, terminate one or more worker processes of the plurality of worker processes.

20. The non-transitory computer-readable medium of claim 19, further comprising instructions that, when executed by the at least one processor, cause the computer system to:
determine a worker memory amount for each of the plurality of worker processes; and
assign a number of worker processes having highest worker memory amounts of the plurality of worker processes as the one or more worker processes to terminate.
